(19) United States
(12) Patent Application Publication
(10) Pub. No.: US 2026/0339380 A1
(43) Pub. Date: Oct. 29, 2026

(54) PERFORMING MULTIPLICATION USING A COLLECTIVE PROPERTY OF ELECTROMAGNETIC SIGNALS

(71) Applicant: Microsoft Technology Licensing, LLC, Redmond, WA (US)

(72) Inventor: Teresa A. NICK, Towson, MD (US)

(73) Assignee: Microsoft Technology Licensing, LLC, Redmond, WA (US)

(21) Appl. No.: 19/187,144

(22) Filed: Apr. 23, 2025

(51) Int. Cl. G06E 3/00

(52) U.S. Cl. CPC G06E 3/008

(57) ABSTRACT

A method for optical multiplication includes displaying a first encoded electromagnetic signal on a shared memory space, the first encoded electromagnetic signal being based on an input value and displaying a second encoded electromagnetic signal on the shared memory space, the second encoded electromagnetic signal being based on a learned parameter associated with the input value. The method includes detecting a cumulative electromagnetic signal on the shared memory space including a combination of at least some of the first encoded electromagnetic signal and at least some of the second encoded electromagnetic signal and determining a product of the input value and the learned parameter based on decoding the cumulative electromagnetic signal.

Artificial intelligence (AI) is used to perform complex tasks such as reading comprehension, language translation, image recognition, or speech recognition. Artificial intelligence systems, such as those based on Natural Language Processing (NLP), Recurrent Neural Networks (RNNs), Convolutional Neural Networks (CNNs), Long Short-Term Memory (LSTM) neural networks, or Gated Recurrent Units (GRUs) have been deployed to perform such complex tasks. In many such systems, parallelism is used to accelerate operations associated with the model. Parallel operations and the multiplication of matrices are utilized for processing information (e.g., inputs or embeddings) though the various layers of the model, and loading memory to perform these operations can present significant bottlenecks, which ultimately degrades performances of artificial intelligence systems during both inference and training.

Accordingly, there is a need for systems and methods that reduce latencies in artificial intelligence models.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 illustrates an example of performing a multiplication computation by displaying electromagnetic signals, according to at least one embodiment of the present disclosure;

FIG. 2-1 illustrates an example operation in which data is computed at a layer L−1 and communicated to a layer L, according to at least one embodiment of the present disclosure;

FIG. 2-2 illustrates an example operation in which data is computed at a layer L−1 and communicated to a layer L, according to at least one embodiment of the present disclosure;

FIG. 3-1 illustrates an example of various nodes of a layer L−1 and various nodes of a layer L, and connections therebetween, according to at least one embodiment of the present disclosure;

FIG. 3-2 illustrates an operation in which weighted activations are computed at the layer L−1 and transmitted to the layer L, according to at least one embodiment of the present disclosure;

FIG. 3-3 illustrates an example of performing multiplication based on the summation of properties of electromagnetic energy, according to at least one embodiment of the present disclosure;

FIG. 4 illustrates an example system environment for performing collective operations using collective properties of electromagnetic energy, according to at least one embodiment of the present disclosure;

FIG. 5 illustrates an example set of signals that may be communicated using electromagnetic energy to perform collective operations associated with artificial intelligence as described herein, according to at least one embodiment of the present disclosure;

FIG. 6 shows a binary encoding and summation technique for improving the dynamic range of values used as part of a collective operation, according to at least one embodiment of the present disclosure;

FIG. 7 illustrates a flow diagram for a method or a series of acts for performing optical multiplication, according to at least one embodiment of the present disclosure; and

FIG. 8 illustrates certain components that may be included within a computer system, according to at least one embodiment of the present disclosure.

### DETAILED DESCRIPTION

Typically, AI systems include various layers, sublayers, or even smaller portions of the artificial AI model that are partitioned to achieve model parallelism. As an example, in parallelism, different processing units in the system may be responsible for the computations in different parts of a single network. For example, each layer, sublayer, or even a smaller portion of the neural network may be assigned to a different processing unit in the system. Thus, as part of parallelism, the neural network model may be split among different processing units (e.g., CPUs, GPUs, IPUs, FPGAs, or other types of such units). Various nodes or neurons make up each layer and are interconnected to form the neural network. As used herein the term “node” or “neuron” refers to a connection point in an AI system having layers for processing inputs and providing outputs, where the connection point has the capability to receive an input and provide an output to other connection points (nodes) in the AI system.

In some embodiments, each processing unit may receive data from a previous processing unit (e.g., a previous layer) and may perform computations on the data for transmitting to a next processing unit (e.g., a next layer). The computations often involve multiplication of a set of input values and associated set of learned parameters. For example, in feed forward neural networks, activation values and an associated set of weight values are used to generate a set of weighted activation values for the various nodes in the layer. The set of weighted activation values may be summed and/or passed on to the nodes of a next layer, where weights of that layer are multiplied thereto to generate weighted activations for that layer, and so on for various, and often many, layers of the model. Each layer typically includes many nodes which are implemented, hosted, or operated by one or more processing units, often graphical processing units (GPUs). Thus, the set of activations and the set of weights for the various nodes in a layer are generally represented via matrices, and the processing unit performs element-wise multiplication thereof to generate the weighted activations. Other portions or operations of AI models may also involve the multiplication of values (e.g., matrices of many values), both during training or learning, and during inference. For instance, query weight matrices, key weight matrices, and/or value weight matrices may be utilized for multiplication computations in connection with input embeddings, for example, as part of a self-attention operation or feature of a model. Thus, the operation of AI models may rely heavily on multiplication computations.

Multiplication in this way for AI models is very memory and computation expensive. For example, it is not uncommon for modern AI models to have trillions of parameters (e.g., nodes), resulting in billions of memory loads and computations (e.g., multiplications) to perform at each layer. Indeed, weight matrices representing learned information at one or more layers are typically quite large, such as up to millions or even billions of weights for each layer. While GPUs are leveraged for their ability to perform large amounts of parallel operations efficiently, the sheer volume of data that needs to be loaded into memory to perform the computations (e.g., multiplications) can present a considerable bottleneck to the operation of an AI model.

Even given that GPUs may be particularly suited for performing a large number of computations, fetching and storing data from memory can nevertheless introduce significant latency issues. For instance, moving data between GPUs (or other processing units) and VRAM (or other memory) is often orders of magnitude slower than the computation itself. Indeed, a considerable amount of the bottleneck/latency issues with AI models is often attributable to the delay in memory access functions. Moreover, AI models require a significant amount of memory resources to store matrices and other data. As memory hardware resources are typically limited, and the volume of data utilized by AI models is continually growing, data overflows spill to slower memory or storage devices, causing further delays.

The present disclosure provides advantageous improvements to these (and other) issues associated with performing multiplication operations in artificial intelligence (AI) models by using a collective property of electromagnetic energy, such as a natural cumulative effect of the intensity of light or optical signals when collocated, superimposed, or overlaid on one another. Indeed, in some embodiments, values (e.g., decimal values) can be encoded as electromagnetic signals and multiplied, including the element-wise multiplication of matrices containing multiple values, based on displaying the electromagnetic signals overlapping on a shared memory space, and detecting or observing the resulting cumulative electromagnetic signal(s). For instance, a property (e.g., light intensity or brightness) of the electromagnetic signals may combine to produce a resulting property (e.g., light intensity or brightness) that represents a sum of the two electromagnetic signals, which property may be relied on to infer a sum of the underlying values. In some cases, multiplication can be performed based on addition or summation in this way, for example, based on the relationship between the addition and multiplication of logarithms.

In this way, a set of activations in an activation matrix may be multiplied by a set of weights values in a weight matrix (e.g., or other multiplication computations of an AI model) for producing weighted activations for the various nodes in a model layer, for example, without relying on a processing unit to perform the actual multiplication computations. Thus, by performing multiplication based on the additive effect of electromagnetic signals as described herein, the memory intensive multiplication operations may be performed with two distinct parallel inputs, providing valuable efficiency gains when considered in the aggregate across the AI model as a whole. Further, for inference, the large learned matrices could be contributed by a processor or device that is optimized for display and contains stored images of the learned matrices or shards thereof, for example, such that voluminous weight matrices do not have to be recalled from memory. Indeed, in some cases, the need for sophisticated and robust GPU's may be eliminated altogether, and the multiplication operations may be achieved based on utilizing only FPGAs, other more efficient processors, or even more basic processing components. By not relying on a processing unit to perform the multiplication computations, including the numerous data transfers between the processing unit and memory to perform the multiplication computations (e.g., storing and/or fetching activation values and/or weight values, intermediate memory usage as part of the multiplication computation, etc.), latency may be significantly reduced, which may further streamline the neural network processing of data at a given model layer and the communication thereof between layers, as well as accelerating self-attention.

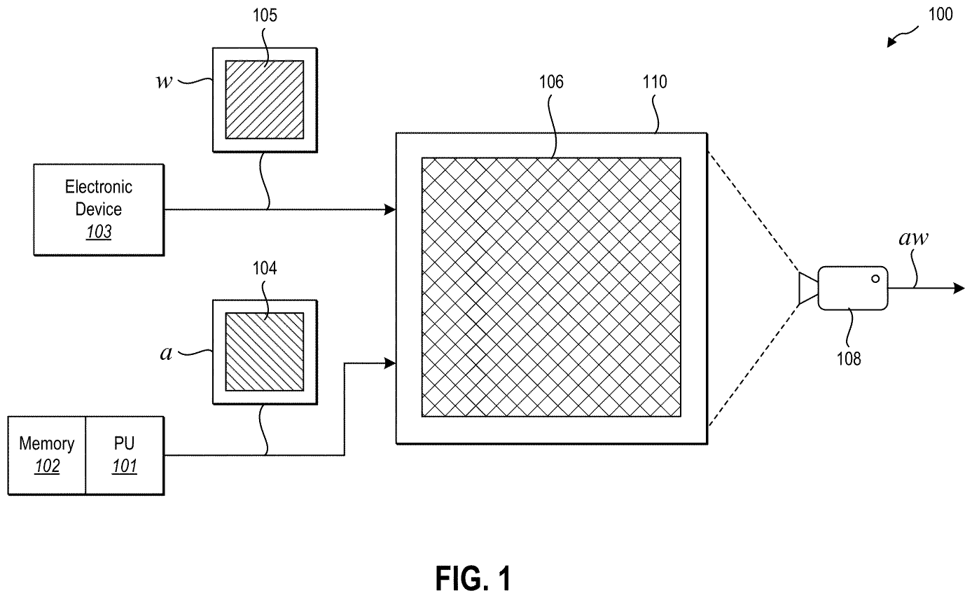

FIG. 1 illustrates an example of a performing a multiplication computation by displaying electromagnetic signals, according to at least one embodiment of the present disclosure. For instance, the multiplication computation may be a multiplication performed as part of operation of an AI or machine learning (ML) model.

A processing unit 101 may include or be associated with a memory 102. The processing unit (PU) may be any type of processing unit, hardware, or component, such as a computer processing unit (CPU), graphics processing unit (GPU), tensor processing unit (TPU), AI accelerator, processing core, logic component, or other. In at least one embodiment, the PU 101 is a CPU, for example, and is not a GPU. The memory 102 may be any of a variety of types of memory such as random access memory (RAM), dynamic random access memory (DRAM), High Bandwidth Memory (HBM), or any other memory as described herein.

In some cases, the PU 101 implements, hosts, operates, or is otherwise associated with a layer of an AI model. For example, the PU 101 may implement various nodes comprising the layer. For this example, the PU 101 may be shown and described with respect to a single node and/or a single connection to another node and/or PU of another layer. For example, the PU 101 may receive or determine a (e.g., single) activation a which may be a value corresponding to the node. In some cases, the activation a is based on activations received from a previous layer and/or node, such as based on an activation function of weighted activations from various nodes and an associated bias. As used herein, an “activation,” “activation value,” or the like may refer to any input value which is received, determined, or which applies specifically to a node of an AI model. For example, an activation may be any value (e.g., number) which is generated and/or received by any portion of an AI model, and may not be limited to only being activation values, for instance, as part of an inferencing operation of an AI model.

As described herein, the activation a may be associated with a corresponding weight w which may be a weight value representative of learned or trained information of an AI model for the node and activation a. For instance, a product of the activation a and the weight w may be a weighted activation “aw,” which may be passed on to a further layer and/or node(s). The PU 101 may store the activation a in the memory 102. It should be understood that the techniques shown and described in connection with FIG. 1 may be applicable to operating (e.g., performing multiplications for) multiple nodes of a layer simultaneously. As used herein, “weight,” “weight value”, or the like may refer to any learned parameter by an AI model. For example, a weight may be any parameter (e.g., number) which is static, known, or learned and which corresponds to an input value for adjusting, modifying, or otherwise weighing the input value.

In some cases, an electronic device 103 manages and/or implements the weight w. For instance, the device may be a PU and associated memory which may store the weight w. In some cases, the electronic device 103 is a display device which facilitates displaying one or more electronic signals associated with the weight w. In some cases, the electronic device 103 is a circuit which may produce and/or display an electromagnetic signal associated with the weight w.

The product value (or a set of product values) representing a product of the weight w and the activation a (e.g., the weighted activation aw) may be achieved based on displaying electromagnetic signals on a shared memory space 110. For example, the shared memory space may be a screen, area, or meta space, where electromagnetic signals may be projected. In some cases, the shared memory space 110 is representative of a device which facilitates displaying multiple electromagnetic signals in a collocated, overlapping and/or superimposed manner such that the multiple electromagnetic signals may sum or aggregate to a resulting cumulative electromagnetic signal. For example, the shared memory space 110 may be a device having one or more transparent displays having emitters or pixels which can activate and emit electromagnetic energy (e.g., light or optical signals) in such a way that, when observed through multiple layers of the transparent display, the electromagnetic signals may aggregate to a cumulative electromagnetic signal. As used herein, electromagnetic signals that are “overlapping,” “overlaid,” “superimposed” or the like should be understood as referring to any configuration, or locating of electromagnetic signals in any manner, in which one or more properties of the electromagnetic signals may combine to produce a cumulative electromagnetic signal having a cumulative electromagnetic property that is a sum of the underlying electromagnetic signals. For instance, in some cases, electromagnetic signals may be projected onto a common space and may physically occupy a same area, and thus may be overlapping or superimposed. In other cases, electromagnetic signals may be displayed via one or more emitters, such as LEDs, which may be collocated or positioned adjacent or in close proximity. For example, emitters displaying one electromagnetic signal may be collocated with emitters displaying another electromagnetic signal and in such proximity that when observed by an image sensor, the electromagnetic signals appear to be combined into a resulting cumulative electromagnetic signal having combined electromagnetic properties (e.g., combined brightness). More details about various embodiments of the shared memory space 110 are described in U.S. patent application Ser. No. 18/526,186, filed Dec. 1, 2023 and Ser. No. 18/737,539, filed Jun. 7, 2024, the entireties of which are incorporated herein by reference.

The PU 101 may generate and display a first electromagnetic signal 104 on the shared memory space 110. For example, the PU 101 may be associated with a projector, one or more emitters, or other device for presenting and/or displaying the first electromagnetic signal 104 on the shared memory space 110. Similarly, the electronic device 103 displays a second electromagnetic signal 105 on the shared memory space 110. For example, the electronic device 103 may generate and display the second electromagnetic signal 105 on the shared memory space 110 in embodiments where the electronic device 103 includes a PU. In some cases, the electronic device 103 is another non-smart or non-processing device, such as a projector and/or a circuit which facilitates presenting the second electromagnetic signal 105. For instance, in some cases the weight wis a learned or static value that may be hard-coded and such that the electronic device 103 may not be relied on to perform processing and/or logic functions. In contrast, the activation a, in some cases, may be dynamic and/or changing, and the PU 101 may receive the activation a, perform one or more computations on the activation a, etc.

The first electromagnetic signal 104 and the second electromagnetic signal 105 may be displayed on the shared memory space 110 such that the two signals at least partially overlap or are at least somewhat superimposed on one another. For example, in some cases the two electromagnetic signals are aligned such that they completely overlap. For instance, the two electromagnetic signals may be the same size and/or shape such that, when displayed, they combined to form a cumulative electromagnetic signal 106. The cumulative electromagnetic signal 106 may be a combination, aggregation, and/or sum of the first electromagnetic signal 104 and the second electromagnetic signal 105. For example, one or more properties of the two electromagnetic signals may combine to produce a resulting property that is exhibited by the cumulative electromagnetic signal 106. In at least one embodiment, a light intensity of the two electromagnetic signals may combine, add, or sum, to a resulting light intensity of the cumulative electromagnetic signal 106. Other properties may combine in this way, such as a color, or other property or electromagnetic energy. In this way, the cumulative electromagnetic signal 106 may exhibit the combined property of the first electromagnetic signal 105 and the second electromagnetic signal 105, which may represent a sum of these two properties. For instance, the summation of the properties may occur naturally and/or inherently, for instance, without a device or processor having specifically performed a summation computation.

An image sensor 108 may detect, measure, or observe the cumulative electromagnetic signal 106 on the shared memory space 110. For example, the image sensor 108 may be a photodetector, light sensor, camera, photodiode, or other type of sensor or measurement device for detecting or receiving electromagnetic signals. Based on the image sensor 108 observing the cumulative electromagnetic signal 106, the combined or summed properties of the first electromagnetic signal 104 and the second electromagnetic signal 105 exhibited by the cumulative electromagnetic signal 106 may be determined. For example, the light intensity of the cumulative electromagnetic signal 106 may be determined, which may represent the combined light intensities of the first electromagnetic signal 104 and the second electromagnetic signal 105. In other examples, other combined properties may be observed.

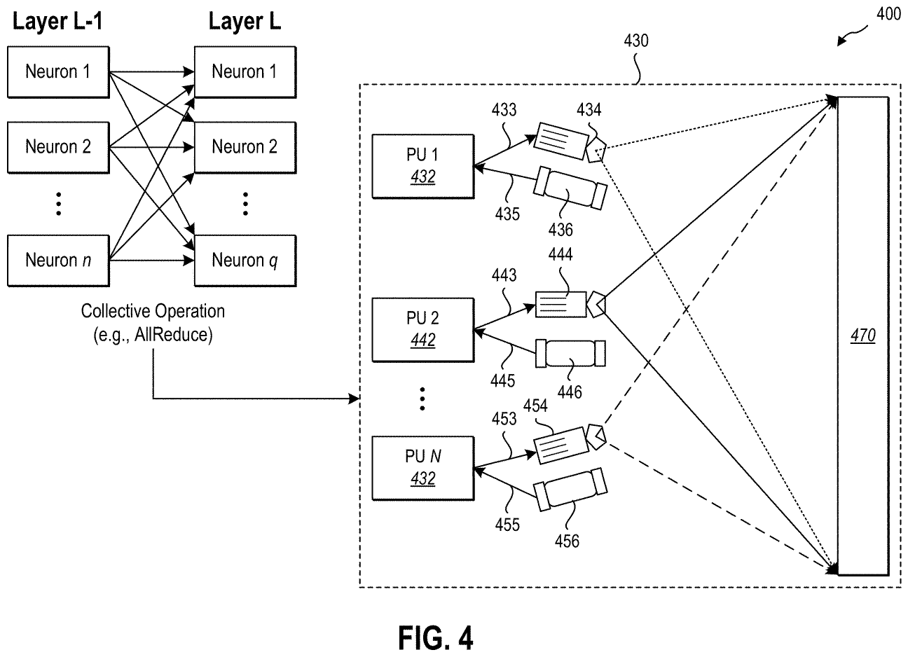

The electromagnetic properties of the electromagnetic signals may be leveraged to encode information. For example, the light intensity may be selected to encode a bit value into an electromagnetic signal. While the first electromagnetic signal 104 and the second electromagnetic signal 105 are shown as a single pixel, bit, or region, this is for simplicity and illustrative purposes. Indeed, the electromagnetic signals may each comprise a pattern of several bits, pixels, and/or regions for encoding information (e.g., the activation a and/or weight w) via any number of bits. For instance, in at least one embodiment, the electromagnetic signals are each a pattern of 16 bits, pixels, or regions, which, through selectively displaying a light intensity at each bit, may convey the underlying decimal value of the activation a and/or weight w. M ore details regarding encoding schemes for electromagnetic signals is described below in connection with FIGS. 4-6. By overlaying the bits, pixels, or regions, of the first electromagnetic signal 104 with those of the second electromagnetic signal 105, the bits, pixels, or regions or each electromagnetic signal may sum (e.g., naturally or inherently through the properties of the electromagnetic signals), which may represent a sum of the underlying decimal values of the activation and the weight. Accordingly, the cumulative electromagnetic signal 106 may be observed by the image sensor 108 to infer the sum of the underlying activation and weight values.

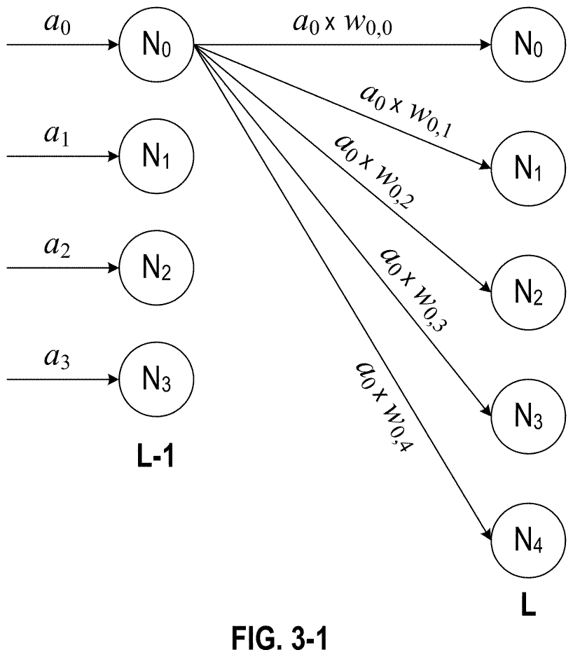

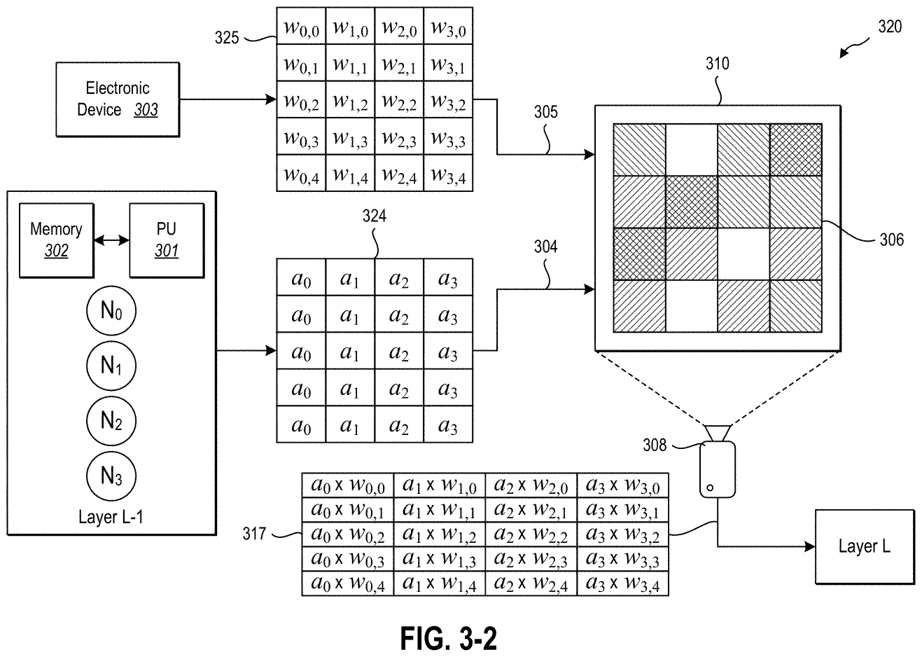

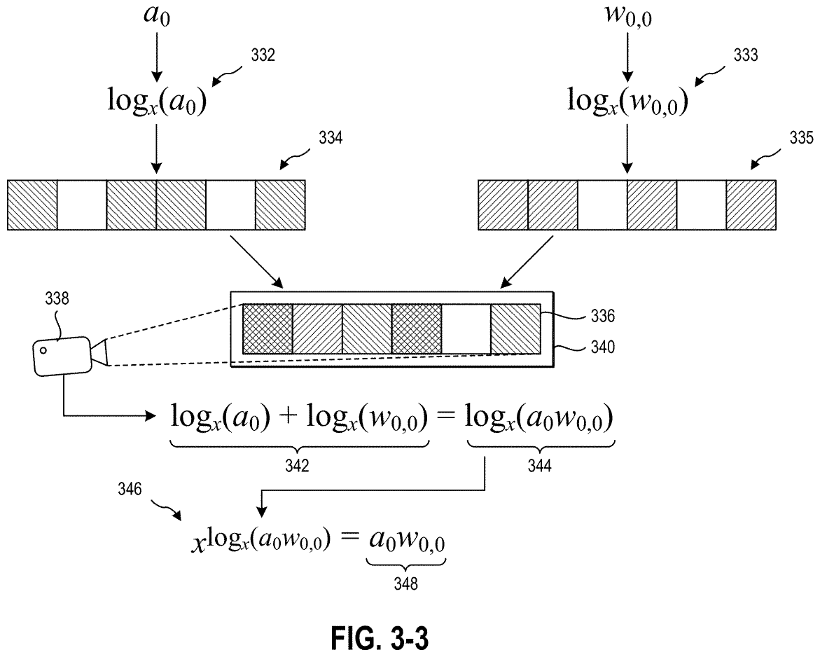

In some cases, this technique of summing values through encoded electromagnetic signals may be leveraged to perform multiplication operations. For example, the product rule of logarithms states that log (xy)=log (x)+log (y). Thus, by leveraging the relationship between addition (e.g., summation) and multiplication of logarithms, the electromagnetic signals may be summed to convey a product. For example, in some cases, the first electromagnetic signal 104 is an encoding of a transformation of the value of the activation a to a logarithmic value. Similarly, the second electromagnetic signal 104 may be an encoding of a transformation of the value of the weight w to a logarithmic value. The sum of these logarithmic values as conveyed via the cumulative electromagnetic signal 106 may be reverse transformed, or exponentiated, to produce the product of the weight w and the activation a. More details related to the logarithmic transformations and multiplication based on summing electromagnetic signals is described below in connection with FIG. 3-3.

Accordingly, based on displaying multiple electromagnetic signals on a shared memory space, one or more properties of the electromagnetic signals may naturally combine and/or sum, which may be leveraged to perform multiplication computations, for example, without a processor or other device actively performing the multiplication computation. As described herein, this technique may be leveraged in AI model implementations to decrease latency and bottlenecks associated with multiplication. Indeed, electromagnetic signals representing multiple (e.g., a matrix of) activation values may be displayed on a shared memory space and overlaid with a display of (e.g., a matrix of) multiple associated weight values such that large-scale multiplication may be performed through the natural summation of electromagnetic signals without relying on processing components to perform the computations.

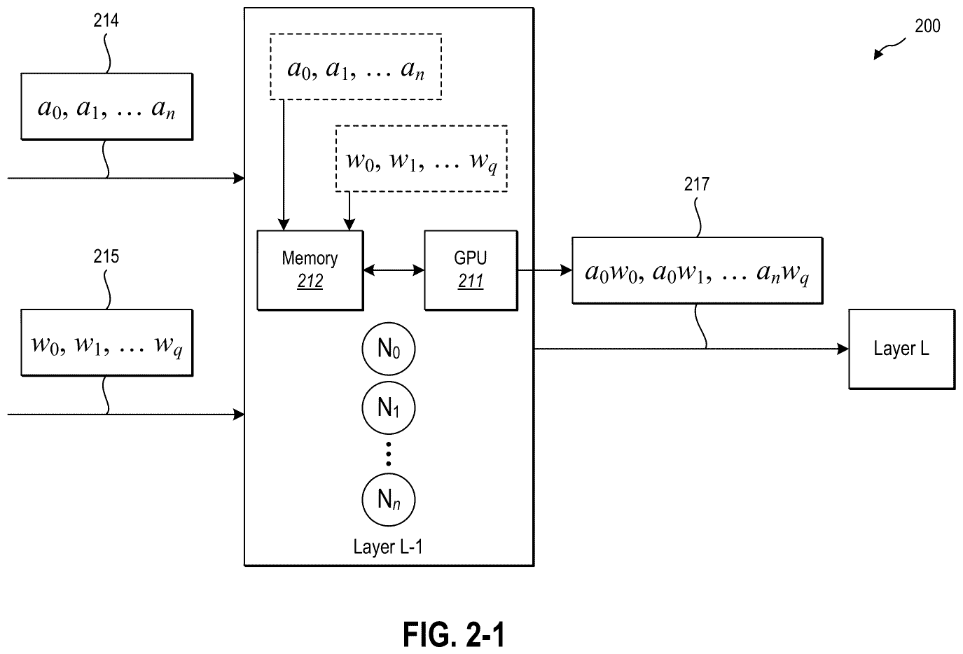

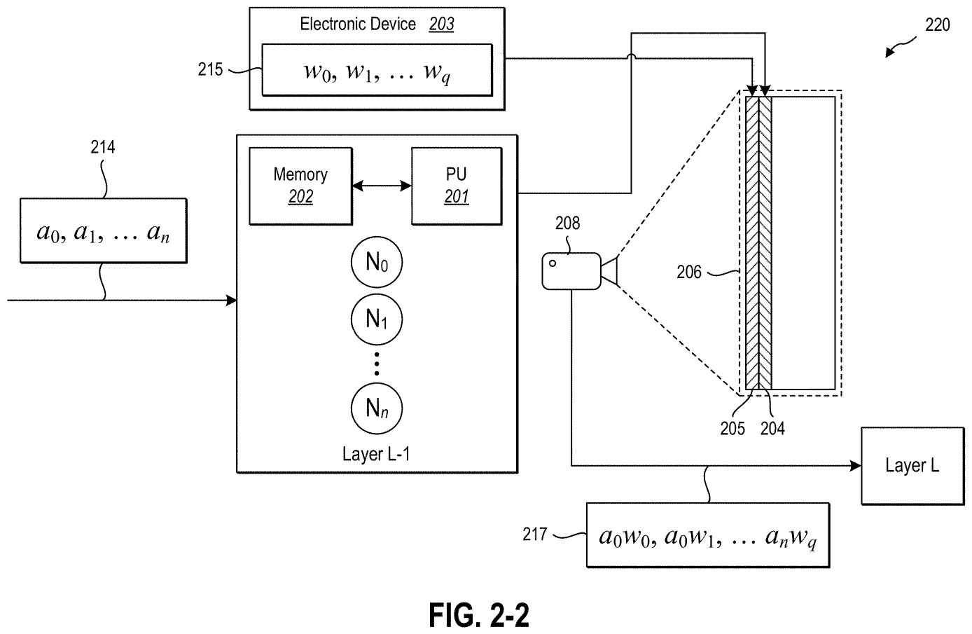

FIG. 2-1 illustrates an example operation 200 in which data is computed at a layer I−1 and communicated to a layer L, according to at least one embodiment of the present disclosure. For instance, the layers L, L−1 may each be layers of an AI model as described herein. The layer L−1 may include a variety of nodes N, including nodes N0, N1 up to Nn. The layer L may also include any number of nodes. In some cases, the example operation 200 of FIG. 2-1 may be representative of a conventional or typical operation of layers of an AI model.

In some cases, the layer L−1 is implemented via a GPU 211 and a memory 212. The layer L−1 may receive various activations 214, such as from one or more nodes of a previous layer (e.g., layer L−2). The operation 200 may involve computing weighted activations 217 for the activations 214, and transmitting the weighted activations 217 to the nodes of the Layer L. In this way, input information (via the activations 214) can be processed at the layer L−1 based on learned information (e.g., weights) for the layer L−1 and communicated to the layer L as part of an operation of an AI model.

In order to generate the weighted activations 217, the layer L−1 may typically rely on the GPU 211 to perform multiplication computations wherein the GPU multiplies each activation 214 by one or more corresponding weights 215. For instance, in some cases the activations 214 may each correspond to a particular node N of the layer L−1, and for each node N in the layer L to which the node N in the layer L−1 is connected, the activation 214 may be adjusted by the weight 215 corresponding to that connection. In some cases, the layer L−1 receives the weights 215 from another device, node, or layer, and loads the weights 215 to memory for use in performing the weighted activation multiplications. In some cases (e.g., with smaller models) the weights 215 may be stored locally by the layer L−1. More information regarding activations, weights, and connections between nodes of different layers is described in connection with FIG. 3-1.

In order to perform multiplication computations and determine the weighted activations 217, the activations 214 may typically have to be loaded into memory 212. Additionally, the weights 215 may also be loaded into memory 212. The activations 214 and weights 215 may each be stored as a corresponding matrix, or any other form for storing and indexing data. As mentioned above, these matrices may typically be quite robust, such as including billions of entries for large AI models. Indeed, the Layers L−1, L may each include millions or billions of nodes, each corresponding to one or more activations and/or weights. Accordingly, the GPU 211 may multiply the individual activations 214 by one or more of the weights 215 to generate the weighted activations 217, which may represent a considerable amount (e.g., thousands, millions, or billions) of computations for the GPU 211 to perform. For instance, the GPU 211 may perform element-wise multiplication of the activation matrix and the weight matrix. As mentioned above, computing multiplications at this scale, and in particular loading and fetching such a large volume of information from memory, can be very computationally expensive, and can represent a significant bottleneck to the efficiency of the operation of the AI model. Indeed, GPU's have often been leveraged (and in some cases specialized tensor processing units have been developed) to attempt to process larger and larger volumes of data more efficiently in order to reduce bottlenecks. The present disclosure provides advantageous techniques for performing large-scale multiplication operations without relying on conventional multiplication computations of a processor.

FIG. 2-2 illustrates an example operation 220 in which data is computed at the layer L−1 and communicated to the layer L, according to at least one embodiment of the present disclosure. In this example, the Layer L−1 may be implemented via a PU 201 and a memory 202. The PU 201 may be any type of processing component, but in at least one embodiment the PU is a CPU, for example, rather than a GPU. For instance, the PU 201 may be a processing component that is not particularly configured for mass parallel operations in the way a GPU is, but rather may be a processing unit having relatively few cores, which may be facilitated by the techniques of the operation 220.

The Layer L−1 may receive activations 214, such as from a variety of nodes of a previous layer (e.g., a layer L−2), and may generate weighted activations 217, or a set of product values for the activations 214 multiplied by corresponding weights 215, for transmitting to the nodes of Layer L. However, rather than performing multiplication computations, for example with the PU 201, to generate the weighted activations 217, the layer L−1 may leverage the display of electromagnetic signals to achieve multiplication in a much more computationally efficient manner. To elaborate, the PU 201 may generate a first electromagnetic signal 204 and may display the first electromagnetic signal 204 on a shared memory space 210. For instance, the shared memory space 210 may be a screen, and the layer L−1 may include a projector for displaying the first electromagnetic signal 204 on the screen.

In some cases, as described herein, the PU 201 may generate the first electromagnetic signal 204 based on performing one or more transformations to the activations 214. For example, the PU 201 may transform the set of activations 214 into a set of logarithmic activations (e.g., log (activation)). The PU 201 may then generate the first electromagnetic signal 205 based on encoding these logarithmic values into a pattern for display on the shared memory space 210. While this transformation, encoding, and display of the activations 214 may involve performing various operations and/or computations with the PU 201, including memory access functions, these operations may be relatively simple operations with may be considerably more computationally efficient than are matrix multiplication computations, as described above in connection with FIG. 2-1. For example, the operation of the Layer L−1 may be implemented via a more basic and/or less sophisticate CPU rather than a more robust GPU enabled for parallelism.

As shown, a second electromagnetic signal 205 may be displayed on the shared memory space 210, which may be indicative of the weights 215. For instance, an additional projector may display the second electromagnetic signal 205. An electronic device 203 may store, access, or otherwise include the weights 215. In some cases, the electronic device 203 stores, accesses, or transforms the set of weights 215 into a set of logarithmic weights as described herein. For instance, in various cases the weights 215 may be learned and/or static information, and the set of logarithmic weights can be hard coded or stored by the electronic device 203. The electronic device 203 may be a PU with associated memory, or may be another component or circuit which may facilitate displaying the second electromagnetic signal 205. For instance, because the weights 215 may be static, and it may not be necessary for the electronic device 203 to perform many (or any) computing and/or logic functions, the electronic device 203 can be a simpler, less sophisticated, and/or less robust device. For instance, in some cases the electronic device 203 may only be tasked with displaying the second electromagnetic signal 205 in connection with the first electromagnetic signal 204 being displayed. In some cases, the electronic device 203 may be implemented as a simple circuit for displaying the second electromagnetic signal 205, for example, without any dedicated memory and/or computing hardware components. For instance, the electronic device 203 may be any device capable of displaying the (e.g., same) second electromagnetic signal 205 continuously and/or repeatedly in connection with a display of the first electromagnetic signal 204.

In some cases, the electronic device 203 may be representative of a functionality of the PU 201. For example, in some cases the electronic device 203 may not be a separate device, but rather, may be performed by the PU 201. In some cases, the PU 201 causes the second electromagnetic signal 205 to be displayed on the shared memory space 210, for instance, via an additional projector. While such a functionality, in some cases, may involve the PU 201 storing and recalling the weights 215 (or logarithmic values of the weights 215) from memory 202, such may nevertheless still produce efficiency gains, as the PU 201 may not be tasked with performing numerous (e.g., billions) of multiplication operations, but rather the multiplication operations may be performed at the shared memory space 210.

The first electromagnetic signal 204 and second electromagnetic signal 205 may be displayed at least partially overlapping, overlaid, and/or superimposed. For example, in some cases, the first electromagnetic signal 204 and the second electromagnetic signal 205 have a same shape and/or size, and may be aligned such that they occupy a same space. For instance, while the first electromagnetic signal 205 is illustrated as being positioned on the shared memory space 210 and the second electromagnetic signal 205 is illustrated as being positioned on top of the first electromagnetic signal 205, in some cases this is merely illustrative of the overlapping nature of these two signals, and both may be positioned or displayed on the shared memory space 210. In some cases, the shared memory space 210 is implemented as one or more (e.g., transparent) displays, and the first and second electromagnetic signals 204, 205 are displayed via emitters or pixels of the displays (e.g., each signal on a separate display) such that, by observing a stack of the displays, a cumulative electromagnetic signal is observed. The shared memory space 210 may be implemented in connection with any of the techniques as described in U.S. patent application Ser. No. 18/526,186, filed Dec. 1, 2023 and Ser. No. 18/737,539, filed Jun. 7, 2024, which have been incorporated by reference in their entireties.

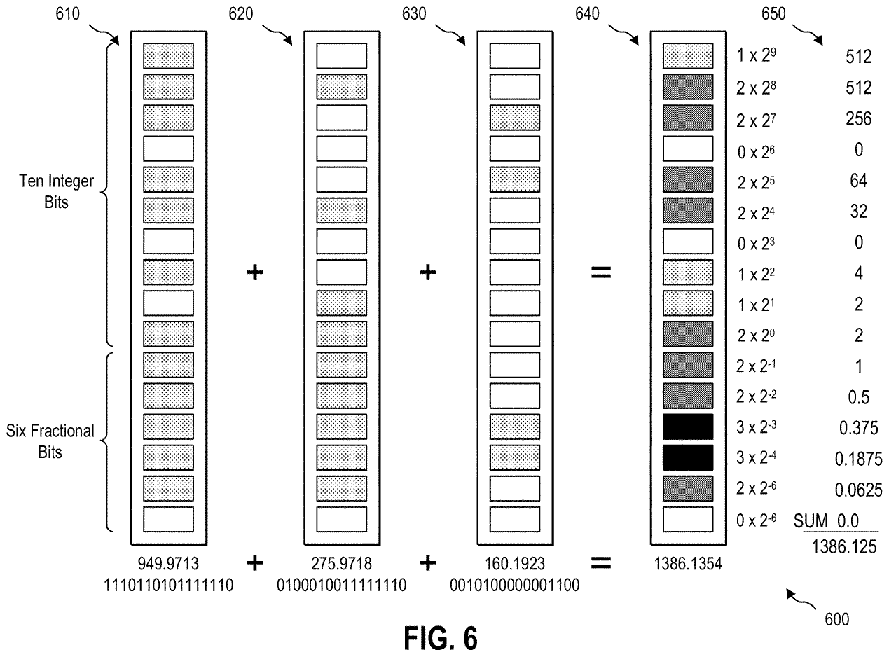

The first electromagnetic signal 204 and the second electromagnetic signal 205 may each include various patterns which may encode bits and/or bit sequences therein for representing underlying data (e.g., underlying decimal values). For example, the activations 214 and the weights 215, and in some cases more specifically the transformed logarithmic values thereof, may be represented as one or more bits encoded via a property of electromagnetic energy. For example, as described herein, a series of bits for each value may be encoded as a pattern having varying light intensities to represent each bit. More information regarding the encoding of electromagnetic signals is described below in connection with FIG. 6. Accordingly, by displaying encodings generated from the activations 214 overlaid with corresponding encodings generated from the weights 215, the overlaid encodings may naturally combine or sum, which may naturally sum the underlying values that the encodings represent. For example, a set of sum values may be decoded from the cumulative electromagnetic signals representing the sum of the underlying (e.g., logarithmic) activation and weight values. This may be performed at scale such that an encoding for each activation 214 may be summed one or more times with encodings of corresponding weights 215. Accordingly, a cumulative electromagnetic signal 206 may result at the shared memory space 210, which may represent corresponding sums (e.g., via a set of sum values) of encodings for each activation-weight pair.

The cumulative electromagnetic signal 206 may be detected, observed, measured, or otherwise received by an image sensor 208, such as a camera, photodetector, or other image sensing device. The image sensor 208 may be associated with the layer L−1, such that the layer L−1 receives or identifies the cumulative electromagnetic signal 206. For example, in some cases the image sensor 208 may be operated or implemented by the PU 201. In some cases, a separate processing unit or component may operate the image sensor 208. In some cases, the image sensor 208 may comprise or include in-line processing capabilities, such as via a field programmable gate array (FPGA) or application-specific integrated circuit (ASIC) for processing images and performing other operations. In this way, the cumulative electromagnetic signal 206 may be observed. In some cases the image sensor 208 is included in or associated with the Layer L, and the layer L may directly observe the cumulative electromagnetic signal 206 and determine the resulting weighted activations. For instance, such a configuration may reduce the amount of data transmitted between the layers based on the Layer L directly obtaining the weighted pairs from observing the cumulative electromagnetic signal 206.

Based on the cumulative electromagnetic signal, the layer L−1 may determine or infer the corresponding products of the activations 214 and weights 215. For example, as mentioned, the first electromagnetic signal 204 and second electromagnetic signal 205 may naturally combine or sum to represent a sum of the underlying values or numbers (e.g., decimal values) that they represent. Because the electromagnetic signals may be encoded based on logarithmic values of the activations 214 and weights 215, the sums as detected through the cumulative electromagnetic signal 206 may be sums of logarithmic activation-logarithmic weight pairs. By leveraging the product rule for logarithms, the product of the activation-weight pairs can be determined from this sum. For example, the Layer L−1 or the layer L (e.g., via the PU 201, in-line processing of the image sensor 208, or other processing unit) may exponentiate the detected logarithmic activation-logarithmic weight sums to reverse transform these sums to a corresponding activation-weight product. In at least one embodiment, the logarithmic transformations of the activations 214 and weights 215 may be based on logarithms having a base of 2, or a binary logarithm. Accordingly, a processing unit (e.g., operating based on binary bit values) may be readily equipped to efficiently exponentiate and/or reverse transform the binary logarithm values based simply on bit shifting. Accordingly, the reverse transformation of the detected logarithmic activation-logarithmic weight sums to activation-weight products may be easily and efficiently performed.

In this way, multiplication may be performed at scale of the activations 214 and their corresponding weights 215 based on displaying encoded electromagnetic signals and observing a cumulative electromagnetic signal. Indeed, rather than performing mass matrix multiplication by relying on processing hardware (e.g., GPUs), all of the multiplication computations may be performed at once at the shared memory space 210 by leveraging the summation properties of electromagnetic signals, and notably, without a PU having performed the actual multiplication computation.

FIG. 3-1 illustrates an example of various nodes N of a layer L−1 and various nodes N of a layer L, and connections therebetween, according to at least one embodiment of the present disclosure. In this example, the layer L−1 includes nodes N₀, N₁, N₂, and N₃, and the layer L includes nodes N₀, N₁, N₂, N₃, and N4. The layers L−1 and L may be layers of an AI model which may include any number, and often many (e.g., thousands, millions, or billions) of nodes, but for simplicity and illustrative purposes, a select few nodes are shown and described.

Each node N of the layer L−1 may receive an activation a, such as from a previous layer (e.g., layer L−2). In some cases, each activation a may be a sum of a collection of several weighted activations, such as a sum of a weighted activation from each node of the previous layer. The layer L−1 may perform various computations on the activations a as described herein, such as to produce weighted activations for each node N to transmit to the nodes N of the layer L. Typically, the nodes N of each layer are connected to each of the nodes N of the next layer in an all-to-all network configuration. Accordingly, each node N of the layer L−1 is connected to each node N of the layer L. The connections between the node N0 of layer L−1 and each of the nodes N₀-N₄ of the layer L are shown in FIG. 3-1 for simplicity, but it should be understood that similar connections exist for each of the nodes N₁-N₃ of the layer L−1.

Each of the connections of the node N0 may correspond to a weight w. For example, while the activation a₀ may be the same for the node No, depending on the receiving node, the activation a₀ may be weighted by a unique weight w corresponding to the receiving node N. For instance, a weight w_{0,0} may correspond to the connection between the node N₀ of the layer L−1 and the node N₀ of the layer L. Similarly, weights w_{0,1}; w_{0,2}; w_{0,3}; and w_{0,4} may correspond to the connections to the nodes N₁-N₄, respectively, of the layer L. In this way, each node may correspond with a single activation a, but may compute and transmit many weighted activations equal to the number of nodes in the receiving layer. For instance, the layer L−1 having 4 nodes and the layer L having 5 nodes may result in 20 weighted activations to compute at layer L−1 and transmit to the nodes of layer L. This all-to-all network configuration of the nodes N further highlights the sheer volume of data to be processed at each layer, which leads to the bottleneck issues discussed herein.

FIG. 3-2 illustrates an operation 320 in which weighted activations are computed at the layer L−1 and transmitted to the layer L, according to at least one embodiment of the present disclosure. The nodes N₀-N₃ of the layer L−1 may be implemented via a memory 302 and PU 301. The layer L−1 may receive activations a₁-a₃ for the nodes N₀-N₃ for the purpose of generating weighted activations to transmit to the nodes N₀-N₄ of the layer L. The weighted activations may be determined based on the electromagnetic signal summation techniques as described herein, for example, rather than the PU 301 performing multiplication computations.

The PU 301 may generate an activation matrix 324 which may be a table or matrix (or other form) which includes a set of activation values, such as a set of activations a₀-a₄. As shown, each row in the activation matrix 324 may include entries corresponding to the activations a₀-a₄, and the rows may be repeated a number of times corresponding to the number of nodes N in the layer L. In this case, there are 5 nodes N₀-N₄ in the layer L, and accordingly each row of the activation matrix 324 may correspond with a receiving node of the layer L, and each column of the activation matrix 324 may correspond with a sending node N of the layer L−1. The activation matrix 324 is illustrated as containing the activations a₀-a₃, but it should be understood that, in some cases, the activation matrix 324 (or another matrix) may be generated by the PU 301 having entries corresponding to the logarithmic transformation of the activations a₀-a₃ as described herein.

Similarly, the electronic device 303 may store or access a weight matrix 325. The weight matrix 325 may be a table or matrix (or other form) including a set of weight values, such as a set of weights w_{0,0}-w_{3,4} corresponding to each of the connections between nodes of adjacent layers as described in connection with FIG. 3-1. For example, each connection may be associated with a unique weight w. Accordingly, the activation a for each node N of the layer L−1 may correspond with several weights, one for each node of the layer L. For example, each entry in the weight matrix 325 may correspond to a particular connection between nodes of the layers L−1 and L. The weight matrix 325 and the activation matrix 324 may accordingly have a same size such that element-wise multiplication may be performed for corresponding pairs of entries in each matrix. As described, in some cases the weight matrix 325 (or another matrix) may be generated having entries corresponding to the logarithmic transformations of the set of weight values w_{0,0}-w_{3,4}.

In some cases, similar to one or more embodiments described herein, the activation matrix 324 may be encoded as one or more first electromagnetic signals 304. For instance, the first electromagnetic signals 304 may represent each of the entries of the weight matrix 325 as a pattern of several (e.g., 16) bits encoded via a property of electromagnetic energy, such as a light intensity. In this way, the activation matrix 324 (e.g., or a logarithmic transformation of the activation matrix 324) may be presented on a shared memory space 310 as represented by electromagnetic signals (e.g., light signals). In a similar manner, the weight matrix 325 (e.g., or a logarithmic transformation of the weight matrix 325) may be encoded as one or more second electromagnetic signals 305 and displayed on the shared memory space 310.

The first electromagnetic signals 304 and second electromagnetic signals 305 may be combined to create a set of one or more cumulative electromagnetic signals 306. For example, the first electromagnetic signals 304 and second electromagnetic signals 305 may be overlaid or superimposed on one another as described herein, and one or more properties of the signals may sum to produce the cumulative electromagnetic signals 306. An image sensor 308 may observe the cumulative electromagnetic signals 306 at the shared memory space 310 and may infer the summations of the underlying values, which may be utilized to determine the products of the weights wand activations a as described herein.

Accordingly, a weighted activation matrix 317 may be generated having entries that correspond with an element-wise multiplication of the entries of the activation matrix 324 and the entries of the weight matrix 325. For instance, the image sensor 308 may have an inline processing component which may perform bit shifting (e.g., or other suitable transformation) in order to convert the logarithmic expressions conveyed via the cumulative electromagnetic signal 306 to the associated products of weight-activation pairs. In this way, the weighted activations for each connection may be transmitted to the layer L. For example, the layer L−1 may transmit the weighted activation matrix 317 to the layer L. In some cases, the layer L may directly detect and determine the weighted activations, for example, based on the image sensor 308 being incorporated or associated with the layer L. In some cases, the various weighted activations for a particular receiving node (e.g., the weighted activations contained in a given row of the weighted activation matrix 317) may be summed. For example, the Layer L may sum the weighted activations for a particular receiving node after receiving the weighted activation matrix 317. In some cases, the layer L−1 (e.g., via the image sensor 308) may sum the rows of the weighted activation matrix 317 and may transmit only these summed weighted activations for each receiving node N to the layer L. By summing the weighted activations at the layer L−1 and only transmitting this summed weighted activation value (e.g., rather than each of the weighted activations), the total volume of data to be transmitted in the network may be reduced, which may provide further efficiency improvements.

In some cases, the various weighted activations as determined in the operation 320 may further be implemented in an operation to perform summation of the weighted activations via electromagnetic signals. For example, rather than utilizing a processing component to compute sums of the rows of the weighted activation matrix 317, a summation operation may be performed based again on leveraging the additive properties of electromagnetic energy to sum the various weighted activations for a receiving node using electromagnetic signals. For example, one or more processing units (e.g., or the PU 301) may cause (e.g., via one or more projectors or other display devices) encoded electromagnetic signals corresponding to each weighted activation to be displayed on another shared memory space. The encoded electromagnetic signal may be overlaid upon one another corresponding to weighted activations to be summed for a particular receiving node. For instance, in the example shown in FIG. 3-2, encoded electromagnetic signals corresponding to the weighted activations a₀w_{0,0}; a₁w_{1,0}; a₂w_{2,0}; and a₃w_{3,0} may be displayed and superimposed to produce a resulting cumulative electromagnetic signal which represents the sum of these 4 weighted activations. The layer L may detect and decoding this cumulative electromagnetic signal, such that the summed weighted activation for node N0 of layer L may be determined, for example, without a PU performing the actual computation, and without transmitting the data between layers by conventional means (e.g., serializing and transmitting through a network). Details related to summing weighted activations using electromagnetic signals in this way are described below in connection with FIGS. 4-6, as well as in U.S. patent application Ser. No. 18/526,186, filed Dec. 1, 2023 and Ser. No. 18/737,539, filed Jun. 7, 2024, which have been incorporated by reference in their entirety.

In this way, by leveraging electromagnetic signals and their ability to additively combine, bottlenecks and other latency issues associated with AI models may be reduced, enabling faster, larger, and more robust AI models. In particular, latency issues related to mass multiplication at AI model layers may be mitigated, providing efficiency benefits for AI model processing

FIG. 3-3 illustrates an example of performing multiplication based on the summation of properties of electromagnetic energy, according to at least one embodiment of the present disclosure. An activation a₀ and corresponding weight w_{0,0} may be associated with a node N of an AI layer as discussed above. Accordingly, in order to process information (e.g., input embeddings) through the AI model, it may be necessary to multiply the activation a₀ by the weight a_{0,0}. In order to multiply these values, the activation a₀ may be transformed into a logarithmic activation 332, and the weight w_{0,0} may be transformed into a logarithmic weight 333. The logarithmic activation 332 and logarithmic weight 333 may be based on logarithms of any base value, but in at least one example are logarithms of base 2, or binary logarithms. As an example, the activation a₀ and the weight w_{0,0} may each be a decimal number which may be transformed by taking the logarithm (e.g., base 2) of those decimal numbers.

The logarithmic activation 332 may be encoded into a first electromagnetic signal 334 and the logarithmic weight 333 may be encoded into a second electromagnetic signal 334. For example, the electromagnetic signals 334, 335 may each be a pattern of various regions, pixels, or bits, which may be displayed having varying light intensities (or other electromagnetic property) for representing a bit sequency (e.g., in binary, or other-order encoding scheme). By displaying both the first electromagnetic signal 334 and the second electromagnetic signal 335 on the shared memory space 340, a cumulative electromagnetic signal 336 is generated. The various regions, pixels, or bits of the electromagnetic signals 334, 335 may combine, add, or sum such that the resulting bits of the cumulative electromagnetic signal 336 are representative of the sum of the underlying electromagnetic signals 334, 335.

An image sensor 338 may observe the cumulative electromagnetic signal 336, which may be decoded to infer a sum value 342 being a sum of the logarithmic activation 332 added to the logarithmic weight 333. Based on the product rule of logarithms, the sum value 342 of the logarithmic activation 332 and the logarithmic weight 333 can be expressed as a the logarithm 344 of the product of the activation a₀ and the weight w_{0,0}. Further, by reverse transforming 346 the logarithmic transformation, or in other words by exponentiating the logarithm 344 with the value of the base of the logarithm 344, the product 348 of the activation a₀ and the weight w_{0,0} can be determined, which may be a weighted activation for a connection between node N0 of layer L−1 and node N₀ of layer L. In a particular example, binary logarithms may be utilized (e.g., logarithms of base 2), which may facilitate performing the reverse transformation 346. For instance, because computers represent numbers in a binary system, exponentiating a base value of 2 can be performed simply through bit shifting. In this way, multiplication operations may be performed based on summing electromagnetic signals overlaid on a shared memory space, for example, rather than relying on a processing unit to perform multiplication computations. While a single multiplication is shown in FIG. 3-3, it should be understood that this technique may be performed as scale, for example, by displaying numerous encoded electromagnetic signals of logarithmic activations overlaid with corresponding encoded electromagnetic signals of logarithmic weights.

FIG. 4 illustrates an example system environment 400 for performing collective operations using collective properties of electromagnetic energy, according to at least one embodiment of the present disclosure. For example, the system environment 400 may be implemented for performing collective operations associated with artificial intelligence (AI) by using properties of electromagnetic energy signals that may collectively interact to form a resulting signal having a collective property. System environment 400 may relate to an artificial intelligence system that, once trained, can be used for predicting outputs as part of inference.

System environment 400 shows the model as including layers L−1 and L, where layer L−1 includes several neurons (neuron 1, neuron 2, and neuron N) and layer L includes several neurons (neuron 1, neuron 2, and neuron Q). For neuron 1 in layer L, the activation is equal to an activation function (∅) on the sum of all weighted inputs or weighted activations (aw) to neuron 1 with some bias

$$b : {a}_{1}^{( l )} = ∅ ( {a}_{1}^{( l - 1 )} {w}_{1 , 1}^{( l )} + {a}_{2}^{( l - 1 )} {w}_{2 , 1}^{( l )} + … + {a}_{n}^{( l - 1 )} {w}_{n , 1}^{( l )} + {b}^{( l )} ) .$$

The inputs

$$( e . g . , {a}_{1}^{( l - 1 )} , {a}_{2}^{( l - 1 )} , and {a}_{n}^{( l - 1 )} )$$

in this example are the set of values for which one needs to predict an output value. These can be viewed as features or attributes included in the data. The weights (e.g.,

$${w}_{1 , 1}^{( l )} , {w}_{2 , 1}^{( l )} , and {w}_{n , 1}^{( l )}$$

are values that are attached to each input to convey the importance of the corresponding input or feature in predicting the final output. The bias (e.g., b^{(l)} can be used to shift the activation function towards left or right. The weights and the bias are parameters that have been learned during training of the AI model.

The activation function (e.g., ∅) is used to introduce non-linearity in the model and the summation function is used to bind the weights and inputs together. Examples of activation functions include rectified linear unit (ReLU) activation function, leaky ReLU, parametric ReLU, Gaussian-error linear unit (GELU) activation function, and other variants of ReLU. Moreover, aside from ReLU any other appropriate non-linear or linear activation functions may be used. In this example, in order to calculate the summation (a₁^{(l)}), one needs information across all of layer L−1, even if the neurons in layer L−1 are partitioned across processing units as part of parallelism. This means that in this example all of the layer L−1 activations would have to be supplied to each processing unit that would calculate layers L's a₁^{(l)} to a_{q}^{(l)}. In other examples, summation may be leveraged to perform multiplication computations, similar to one or more embodiments described herein.

The system environment 400 shows system 430, which is one example implementation for performing a collective operation as part of the AI system. System 430 includes several processing units (e.g. processing units PU 1 432, PU 2 442, and PU N 452). Each of the processing units can be a graphics processing unit (GPU). As explained earlier, the processing units can be implemented using other hardware options, as well. As an example, a processing unit may be implemented as one or more computer processing units (CPUs), field programmable gate arrays (FPGAs), application specific integrated circuits (ASICs), erasable and/or complex programmable logic devices (PLDs), programmable array logic (PAL) devices, or generic array logic (GAL) devices. In this example, each of the processing units is further coupled to a projector and a camera. As an example, PU 1 432 is coupled via link 433 to projector 434 and is also coupled via link 435 to camera 436. PU 2 442 is coupled via link 443 to projector 444 and is also coupled via link 445 to camera 446. PU N 452 is coupled via link 453 to projector 454 and is also coupled via link 455 to camera 456. Each of links 433, 443, and 453 may be implemented as a display port link. Other high-speed links for connecting processing units to projectors may also be used. Each of links 435, 445, and 455 may be implemented as a peripherals component express (PCIe) link. Oher high-speed links for connecting processing units to cameras may also be used. Each projector is configured to project information communicated via electromagnetic energy onto the surface of a shared memory space 470. Other configurations that aggregate part of the data before projection are possible, depending on the model size and design. For example, all of the processing units in one server or one rack could share a projector and a camera. While the example in FIG. 4 is illustrated in relation to projecting electromagnetic signals onto a shared memory space 470, the projectors may be representative of any display device, for example, for facilitating other techniques of displaying electromagnetic signals on a shared memory space 470. For instance, in some cases the projectors may be representative of different displays which may be stacked and which may be collectively viewed (e.g., through each other as transparent displays) for observing a collective electromagnetic signal as described herein. In some embodiments the projectors may be different sets of emitters (e.g., LEDs) which may be disposed in a common medium for displaying various electromagnetic signals in a shared memory space. In some cases, the projectors may be representative of devices displaying different sets of emitters, the sets of which can be collocated and in such proximity that when observed, the electromagnetic signals displayed at each set of emitters appears as one cumulative electromagnetic signal exhibiting cumulative electromagnetic properties of the underlying electromagnetic signals.

In some cases, each processing unit is configured to process one or more neurons associated with a layer. As an example, assuming there are 256 neurons in layer L, PU 1 432 may be configured to process a subset of the 256 neurons, PU 2 442 may be configured to process the next subset of the 256 neurons, and finally PU N 452 may be configured to process the last subset of the 256 neurons. Partitioning may be performed using code configured to partition the model based on machine language frameworks, such as Tensorflow, Apache M×Net, and Microsoft® Cognitive Toolkit (CNTK). Thus, the various layers of the model may be assigned for processing using different processing units. This way the various parameters associated with layers may be processed in parallel. In some cases, two or more processors may be associated with a same layer of a model. For example, as described herein, one processor may be associated with generating and displaying electromagnetic signals for activation values and another processor (or other non-processing electronic device) may be associated with displaying electromagnetic signals for weight values as described herein. In such a case, the system 430 may be implemented with only two sets of processors and projectors. In some cases, only one camera may be implemented.

In one example, the neural network model may comprise of many layers and each layer may be encoded as matrices or vectors of weights expressed in the form of coefficients or constants that have been obtained via training of a neural network. Taking the LSTM example, an LSTM network may comprise a sequence of repeating RNN layers or other types of layers. Each layer of the LSTM network may consume an input at a given time step, e.g., a layer's state from a previous time step, and may produce a new set of outputs or states. In the case of using the LSTM, a single chunk of content may be encoded into a single vector or multiple vectors. As an example, a word or a combination of words (e.g., a phrase, a sentence, or a paragraph) may be encoded as a single vector. Each chunk may be encoded into an individual layer (e.g., a particular time step) of an LSTM network. An LSTM layer may be described using a set of equations, such as the ones below:

iₜ=σ(Wₓᵢxt+Wₕᵢhₜ₋₁+W_{ci}cₜ₋₁+bᵢ)

fₜ=σ(W_{xf}xₜ+W_{hf}hₜ₋₁+W_{cf}cₜ₋₁+b_{f})

cₜ=fₜcₜ₋₁iₜ tanh (W_{xc}xₜ+W_{hc}hₜ₋₁+b_{c})

oₜ=σ(Wₓₒxₜ+Wₕₒhₜ₋₁+W_{co}cₜ+bₒ)

hₜ=oₜ tanh(cₜ)

In this example, inside each LSTM layer the inputs and hidden states may be processed using a combination of vector operations (e.g., dot-product, inner product, or vector addition) and non-linear functions. In certain cases, the most compute intensive operations may arise from the dot products, which may be implemented using dense matrix-vector and matrix-matrix multiplication routines. Although FIG. 4 shows system 430 as including certain components that are arranged in a certain manner, system 430 may include additional or fewer components arranged differently. As an example, shared memory space 470 could be a wall or a microLED array.

System 430 and the associated models can be deployed in cloud computing environments. Cloud computing may refer to a way for enabling on-demand network access to a shared pool of configurable processing units. For example, cloud computing can be employed in the marketplace to offer ubiquitous and convenient on-demand access to the shared pool of configurable processing units. The shared pool of configurable processing units can be rapidly provisioned via virtualization and released with low management effort or service provider interaction, and then scaled accordingly. A cloud computing model can be composed of various characteristics such as, for example, on-demand self-service, broad network access, resource pooling, rapid elasticity, measured service, and so forth. A cloud computing model may be used to expose various service models, such as, for example, Hardware as a Service (“HaaS”), Software as a Service (“SaaS”), Platform as a Service (“PaaS”), and Infrastructure as a Service (“laaS”). A cloud computing model can also be deployed using different deployment models such as private cloud, community cloud, public cloud, hybrid cloud, and so forth.

Although transmission bandwidth as described herein may be limited by visible light peripherals, such as displays and image sensors operating based on visible light, that are optimized for relatively slow human vision, this limit does not present a technological barrier. For example, in some embodiments, peripherals for generating electromagnetic signals (e.g., projectors, displays, etc.) and for receiving or sensing electromagnetic energy signals (e.g., image sensors or light sensors) may be implemented which may operate based on electromagnetic energy that is not in the visible spectrum and/or optimized for speeds above that which human vision can detect. For instance, electromagnetic energy from at least infrared rays to ultraviolet rays, including visible light, may be used with the systems and methods described herein. In terms of wavelength, the electromagnetic energy may range from nanometers (e.g., 400 nanometers) to a few microns (e.g., 1.6 microns). The specific range of wavelength that is used will depend on the type of displays, sensors, or other such equipment being used for the communication of the electromagnetic energy. As an example, radiofrequency waves in a range of 3 kHz to 300 MHz may be used. As another example, microwaves in a range of 300 MHz to 300 GHz may also be used. Depending on the frequency, and thus the wavelength, of the electromagnetic energy being used, the equipment used for communicating such signals may be tailored.

While FIG. 4 is shown and described with respect to displaying and summing multiple weighted activations for a layer of nodes of an AI model, it should be understood that a similar system architecture may be implemented for performing the multiplication techniques as described herein. For example, for multiplication, only two processing units and two display devices (e.g., projectors) may be utilized for facilitating the multiplication of two values (or two matrices of values). For instance, a first processing unit and projector may display one or more input or activation values, and a second processing unit and projector may display one or more weight values or learned parameters. Accordingly, the multiplication of the activation value(s) and weight value(s) may be achieved as described herein. Additionally, in some cases the weight value(s) (e.g., weight matrix) may be displayed without relying on a processing unit. For example, because the weight values are learned and/or static information, a simple switched circuit may be implemented for displaying the (e.g., static) weight value(s) without performing any processing and/or logic functions (e.g., without loading the weight values(s) from memory).

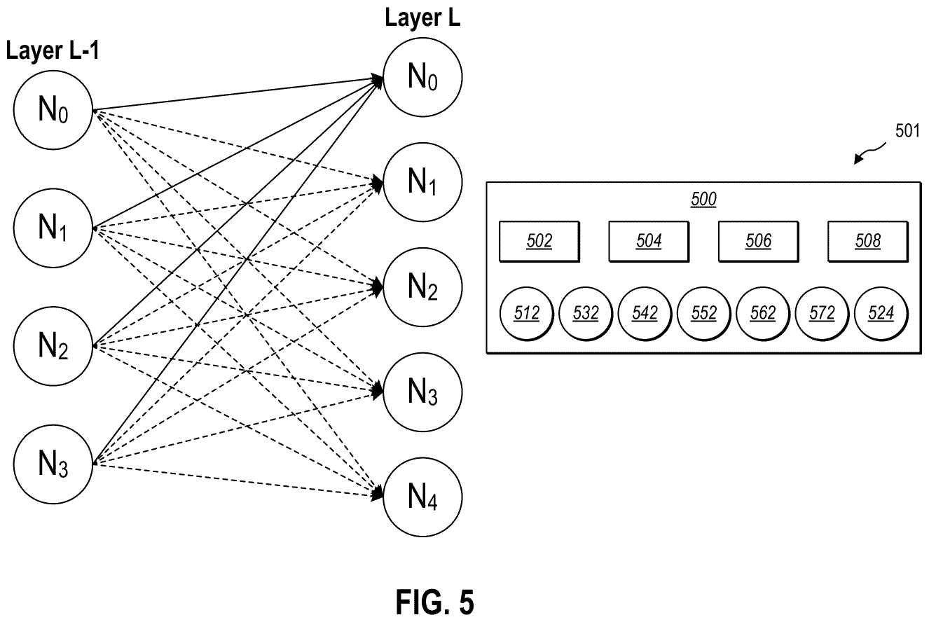

FIG. 5 shows an example set of signals 501 that may be communicated using electromagnetic energy to perform collective operations associated with artificial intelligence as described herein, according to at least one embodiment of the present disclosure. To explain the signals 501, four neurons N₀, N₁, N₂, and N₃ are shown fof layer L−1 and five neurons N₀, N₁, N₂, N₃, and N₄ are shown fof layer L. This example relates to inference and shows the use of the electromagnetic energy's use in the context of signals being communicated from each of the four N₀, N₁, N₂, and N₃ of layer L−1 to neurons of layer L. Accordingly, the weights wand bias b are known and can simply be stored local to the processing unit corresponding to the neurons. Thus, in this example, only the new input data to be processed by the neurons in layer L needs to be sent from each of the neurons of layer L−1 to neuron NO of layer L. Neuron NO of layer L needs to compute

$${a}_{0}^{( l )} = ∅ ( {a}_{0}^{( l - 1 )} {w}_{0 , 0}^{( l )} + {a}_{1}^{( l - 1 )} {w}_{1 , 0}^{( l )} + {a}_{2}^{( l - 1 )} {w}_{2 , 0}^{( l )} + {a}_{3}^{( l - 1 )} {w}_{3 , 0}^{( l )} + {b}^{( l )} ) .$$

To enable this computation, neuron N0 of layer L−1 needs to send the value of

$${a}_{0}^{( 1 - 1 )} {w}_{0 , 0}^{( l )}$$

to neuron N0 of layer L. Neuron N₁ of layer L−1 needs to send the value of

$${a}_{1}^{( 1 - 1 )} {w}_{1 , 0}^{( l )}$$

to neuron N0 of layer L. Neuron N2 of layer L−1 needs to send the value of

$${a}_{2}^{( 1 - 1 )} {w}_{2 , 0}^{( l )}$$

to neuron N0 of layer L. Neuron N3 of layer L−1 needs to send the value of

$${a}_{3}^{( 1 - 1 )} {w}_{3 , 0}^{( l )}$$

to neuron N0 of layer L. Neuron N0 to neuron N5 of layer L need to communicate the activation sum signals to the next layer of the model.

With continued reference to FIG. 5, in this example, the luminous intensity of the electromagnetic energy (e.g., the luminous intensity of visible light) is used to communicate data from each of the neurons (N0, N1, N2, and N3 of layer L−1) to the neurons associated with the next layer (layer L). The shared memory space 500 shows projected light shapes to illustrate example signals communicated by a processing unit (e.g., any of the processing units described earlier with respect to FIG. 4). In this example, three types of signals are shown projected on shared memory space 500. These include individual references signals 502, 504, 506, and 508, population reference signals 512 and 514, and population sum signals 532, 545, 552, 562, and 572. The location and shape of each signal on shared memory space 500 provides additional information, including as an example, the source of the signal and/or the purpose of the signal. Some of these signals facilitate communication among processing units and others communicate actual data used by the next layer for computation. The reference signals can be viewed as metadata or header information. As an example, each individual reference signal (e.g., 502) indicates whether a particular layer L−1 neuron has voted. Thus, the projected light on shared memory space 500 in the left most and top-most location indicates that neuron NO of layer L−1 has voted. Individual reference signals 502, 504, 506, and 508 may also enable population tracking of missing tensor slices and processing units, as well. Moreover, such signals may allow normalization of the signals across the processing units (e.g., GPUs). In other examples, the individual reference signals 502, 504, 506, and 508 may be used for various ways to facilitate communication and calibration of system 430 of FIG. 4. As another example, CPU-based applications can use “efference copy” feedback to adjust luminance and align projections across the processing units during the setting up of system 430 of FIG. 4. As an example, during communication of the electromagnetic energy (e.g., via a projector) a sender can simultaneously transmit and check what is being sent, and then adjust based on the feedback. Thus, if the sender is expecting to project a piece of data, but somehow the shared screen becomes obstructed, the sender will not see the data on the screen that it expected to see. Based on this “efference copy” feedback, the sender can project the data onto another spot on the screen until the feedback confirms that what is being sent is indeed being projected at the right spot on the screen.

A population reference signal (e.g., 512) is a result of electromagnetic energy (e.g., visible light) being projected by those neurons that are participating in the collective operation. The maximum luminous intensity associated with the population reference signal indicates that all of the neurons from a layer (e.g., layer L−1) are participating as part of the collective operation. The population reference signals 512 and 514 can also be used for calibration of the property of the electromagnetic energy across the processing units. In addition, the population reference signals 512 and 514 can also be used for the alignment of the projected information with the cameras. The population reference signals 512 and 514 may also be used to monitor signal drift through the amplitude of a population of neurons, which may also be viewed as the population of the tensor slices, that are participating in a collective operation being performed as part of system 430 of FIG. 4. The population reference signals 512 and 514 may also be used to track the population of the processing units that are participating in a collective operation being performed as part of system 430 of FIG. 4. The shared memory space 500 shows redundant population reference signals. Thus, both population reference signals 512 and 514 are communicating the same information in a redundant manner. There are several situations in which the population reference signals 512 and 514 and the individual reference signals 502, 504, 506, and 508 can be useful during system setup and management. As an example, there may be a situation where a processing unit has a system fault or has a lot more data to process than it can handle, and thus that processing unit may be unable to participate in the collective operation. Thus, the use of these signals is a way of telling the receiving layer everybody has checked in. The individual reference signals can also be helpful in determining if there is a projector that has a faulty bulb or has another type of fault. If one of the individual reference signals (e.g., any of 502, 504, 506, and 508) is darker than the others and if each one of them is calibrated to have the same luminous intensity, then it indicates that there is a problem in the system that needs to be addressed before using the system.

Still referring to FIG. 5, the population sum signals 532, 545, 552, 562, and 572 provide information for use with the neurons in the next layer. Each of the neurons associated with layer L−1 projects electromagnetic energy (e.g., visible light), whose intensity is proportional to that neuronal connection's weighted activation, at a specific spot associated with shared memory space 500. As an example, population sum signal 532 is a result of the summation of the weighted activation signals

$$( e . g . , {a}_{0}^{( l - 1 )} {w}_{0 , 1}^{( l )} , {a}_{1}^{( l - 1 )} {w}_{1 , 1}^{( l )} , {a}_{2}^{( l - 1 )} {w}_{2 , 1}^{( l )} , and {a}_{3}^{( l - 1 )} {w}_{3 , 1}^{( l )} )$$

received from all four neurons (N₀, N₁, N₂, and N₃) of layer L−1 at the specific spot on shared memory space 500 that is associated specifically with population sum signal 532. Population sum signal 542 is a result of the summation of the weighted activation signals

$$( e . g . , {a}_{0}^{( l - 1 )} {w}_{0 , 2}^{( l )} , {a}_{1}^{( l - 1 )} {w}_{1 , 2}^{( l )} , {a}_{2}^{( l - 1 )} {w}_{2 , 2}^{( l )} , and {a}_{3}^{( l - 1 )} {w}_{3 , 2}^{( l )} )$$

received from all four neurons (N₀, N₁, N₂, and N₃) of layer L−1 at another specific spot on shared memory space 500 that is associated specifically with population sum signal 542. Population sum signal 552 is a result of the summation of the weighted activation signals

$$( e . g . , {a}_{0}^{( l - 1 )} {w}_{0 , 3}^{( l )} , {a}_{1}^{( 1 - 1 )} {w}_{1 , 3}^{( l )} , {a}_{2}^{( l - 1 )} {w}_{2 , 3}^{( l )} , and {a}_{3}^{( l - 1 )} {w}_{3 , 3}^{( l )} )$$

received from all four neurons (N₀, N₁, N₂, and N₃) of layer L−1 at another specific spot on shared memory space 500 that is associated specifically with population sum signal 552. Population sum signal 562 is a result of the summation of the weighted activation signals

$$( e . g . , {a}_{0}^{( l - 1 )} {w}_{0 , 4}^{( l )} , {a}_{1}^{( l - 1 )} {w}_{1 , 4}^{( l )} , {a}_{2}^{( l - 1 )} {w}_{2 , 4}^{( l )} , and {a}_{3}^{( l - 1 )} {w}_{3 , 4}^{( l )}$$

received from all four neurons (N₀, N₁, N₂, and N₃) of layer L−1 at another specific spot on shared memory space 500 that is associated specifically with population sum signal 562. Finally, population sum signal 572 is a result of the summation of the weighted activation signals

$$( e . g . , {a}_{0}^{( l - 1 )} {w}_{0 , 5}^{( l )} , {a}_{1}^{( l - 1 )} {w}_{1 , 5}^{( l )} , {a}_{2}^{( l - 1 )} {w}_{2 , 5}^{( l )} , and {a}_{3}^{( l - 1 )} {w}_{3 , 5}^{( l )} )$$

received from all four neurons (N₀, N₁, N₂, and N₃) of layer L−1 at another specific spot on shared memory space 500 that is associated specifically with population sum signal 572.

As explained earlier with respect to FIG. 4, a processing unit and its associated projector can project the population sum signals of its input neurons on the specific spots associated with respective target neurons. The spots themselves could be arranged in a matrix form with x and y coordinates associated with each spot. Other ways may also be used to indicate the association between a spot and the signal associated with that spot on shared memory space 500.

With continued reference to FIG. 5, one or more cameras associated with one or more processing units for the neurons of the next layer could pass the luminous intensity to such processing units. The processing unit may then perform the computation:

$${a}_{1}^{( l )} = ∅ ( {a}_{0}^{( l - 1 )} {w}_{0 , 1}^{( l )} + {a}_{1}^{( l - 1 )} {w}_{1 , 1}^{( l )} + {a}_{2}^{( l - 1 )} {w}_{2 , 1}^{( l )} + {a}_{3}^{( l - 1 )} {w}_{3 , 1}^{( l )} + {b}^{( l )} ) ,$$

$$where {a}_{0}^{( l - 1 )} {w}_{0 , 1}^{( l )} + {a}_{1}^{( l - 1 )} {w}_{1 , 1}^{( l )} + {a}_{2}^{( l - 1 )} {w}_{2 , 1}^{( l )} + {a}_{3}^{( 1 - 1 )} {w}_{3 , 1}^{( l )}$$

is provided by the summed luminance overlay of the input signals for each neuron. This would result in the completion of the collective operation (e.g., AllReduce) in one step using the electromagnetic energy (e.g., visible light). Although FIG. 5 shows a certain number and arrangement of neurons for the layers, each layer may include additional or fewer neurons. Moreover, the neurons for different layers can be supported by the same processing unit or different processing units. In addition, although FIG. 5 shows shared memory space 500 with a certain arrangement and type of signals, shared memory space 500 may include additional or fewer signals that are arranged differently. The shared memory space 500 itself may be a wall or any other structure that can be used for sharing of the luminous intensity or other properties associated with the electromagnetic energy.

In addition, although FIG. 5 shows the movement of data from layer L−1 to L, the movement of data may be in the opposite direction, as well. As noted earlier, during training as part of backpropagation, model parameters are updated by backflow of error gradients. Weight and bias parameter updates are applied during backpropagation. Thus, during training as part of a backward pass a layer of an AI model provides results of the loss or error computation by neurons in that layer to the neurons for the previous layer (e.g., neurons in layer L provides the results to the neurons in layer L−1 of FIG. 5). The gradient of a loss function with respect to the weights and bias in the network (or a portion of the network) is calculated. The gradient is then fed to an optimization method that uses the gradient to update the weights to minimize the loss function. The goal with backpropagation is to update each of the weights (or at least some of the weights) in the network so that they cause the actual output to be closer to the target output, thereby minimizing the error for each output neuron and the network as a whole. As used herein, the term “population sum signal” described earlier refers to gradient of the error in the context of backpropagation while training the AI model. Conversely, in the context of inference the “population sum signal” refers to the population activation sum signal.

While the various signals displayed on the shared memory space 500 are described as being associated with summing weighted activations for nodes of a layer of an AI model, these techniques may be utilized in a similar manner for performing multiplication computations as described in one or more embodiments herein. For example, as described herein, multiplication operations may be performed based on performing summation with electromagnetic signals. Accordingly, one or more of the signals shown and described as presented on the shared memory space 500 may also be utilized for performing multiplication computations. For instance, rather than facilitating the simultaneous summation of multiple weighted activations and for multiple nodes as just mentioned, the population sum signals may represent multiple activations superimposed with associated weights to perform multiplication thereof, as described herein. In such a case, each population sum signal may be representative of a sum of 2 underlying population signals, for example, for facilitating the multiplication of two underlying values (e.g., a weight and an activation).

FIG. 6 shows a binary encoding and a summation technique 600 for improving the dynamic range of values used as part of the collective operation, according to at least one embodiment of the present disclosure. Although binary representation of values as part of the model processing may have higher accuracy, this comes at the expense of transmission bandwidth. Accuracy and bandwidth can be optimized for each use case. To simplify the processing while maintaining a reasonable dynamic range of the values, fixed point representation of values may be used. In one example, fixed point representation may use a set number of integer bits and fractional bits to express numbers. Fixed point values can be efficiently processed in hardware with integer arithmetic, which may make it a preferred format for use with the systems described herein. Fixed point format may be represented as X.Y, where X is the number of integer bits and Y is the number of fractional bits. Block-floating point (BFP) may apply a shared exponent to a block of fixed point numbers; for example, a vector or matrix. The shared exponent may allow a significantly higher dynamic range for the block, although individual block members have a fixed range with respect to each other. Quantization involving mapping continuous or high-precision values onto a discrete, low-precision grid, may be used to arrive at the fixed point representations of the floating point values. If the original points are close to their mapped quantization value, then one expects that the resulting computations will be close to the original computations.

With continued reference to FIG. 6, as part of the binary encoding and summation technique 600 the population sum signals (e.g., similar to 532, 542, 552, 562, and 572 of FIG. 5) may be encoded using fixed point integer values. In the example shown in FIG. 6, the fixed point integer values include ten integer bits and six fractional bits. Column 610 corresponds to the population sum signal from one or more neurons of the input layer from one processing unit to one target neuron. Column 620 corresponds to the population sum signal from another processing unit with input neuron(s) to the same target neuron, and column 630 corresponds to the population sum signal from another processing unit with input neuron(s) to the same target neuron. Column 640 shows the bitwise addition of the fixed point integer values of columns 610, 620, and 640, which together comprise the summed weighted activations for one target neuron. Column 610 represents the output of one of the processing units shown in FIG. 4, column 620 represents the output of another one of the processing units shown in FIG. 4, and column 630 represents the output of yet another one of the processing units shown in FIG. 4. Column 650 shows the computation including an error when summing up the binary numbers, which equals the total activations for one target neuron.

As depicted in column 640, the location (e.g., identifiable via a row number and a column number or on a grid associated with a surface) of the signals in the column corresponds to a weight of that location. As an example, the topmost entry in the column for the spaces corresponding to the ten integer bits has the largest weight (29). The next entry below in the column for the spaces corresponding to the ten integer bits has a weight of 28. The weight of each of the next entries below continues to go down until the tenth integer bit in this example, which has a weight of 2°. The next entries in column 640 correspond to the six fractional bits. These entries' weights also depend on the location in the column.

As shown by the differences in the intensity of gray shading in column 640, the information for the collective operation is communicated using the electromagnetic energy. Thus, similar to the signals shown as part of shared memory space 500 of FIG. 5, column 640 when projected (or otherwise displayed) on a shared memory space can be used to communicate using a binary encoding the population sum signal for use with the neurons in the next layer of the model. Although FIG. 6 shows the intensity differences in gray, colors (e.g., blue and red) with different intensities can be used to communicate this information. The color information can be used to communicate the sign (positive or negative) associated with a binary value. The receiving hardware (e.g., a camera with an A SIC processing board) and software can then parse the red and blue signals and provided them for calculation of

$${a}_{0}^{( l - 1 )} {w}_{0 , 1}^{( l )} + {a}_{1}^{( l - 1 )} {w}_{1 , 1}^{( l )} + {a}_{2}^{( l - 1 )} {w}_{2 , 1}^{( l )} + {a}_{3}^{( 1 - 1 )} {w}_{3 , 1}^{( l )} ,$$

which has been simplified through the projection overlay process to sum positive activations and negative activations. In some embodiments, color encodes other information and two's complement is used for encoding sign.

While the encoding and summation scheme of FIG. 6 has been shown and described as being applicable to summing multiple (e.g., in this case 3) discrete weighted activations, the encoding and summation scheme may similarly be implemented for performing multiplication computations by summing electromagnetic signals as described herein. For example, in some multiplication computations, only two columns (e.g., 610 and 620) may be utilized, such as for multiplying two underlying values (e.g., activation and weight) together. The resulting column 640 may then be a sum of two electromagnetic signals, which can be utilized (e.g., through logarithmic transformation as described herein) to achieve multiplication by summing electromagnetic signals. Thus, the encoding scheme for generating electromagnetic signals to represent underlying decimal values may be utilized in any situation in which it may be advantageous to sum two values through the additive properties of electromagnetic energy, such as for summing multiple weighted activations as shown in FIG. 6, but also for determining or calculating weighted activations by multiplying weight values by activation values.

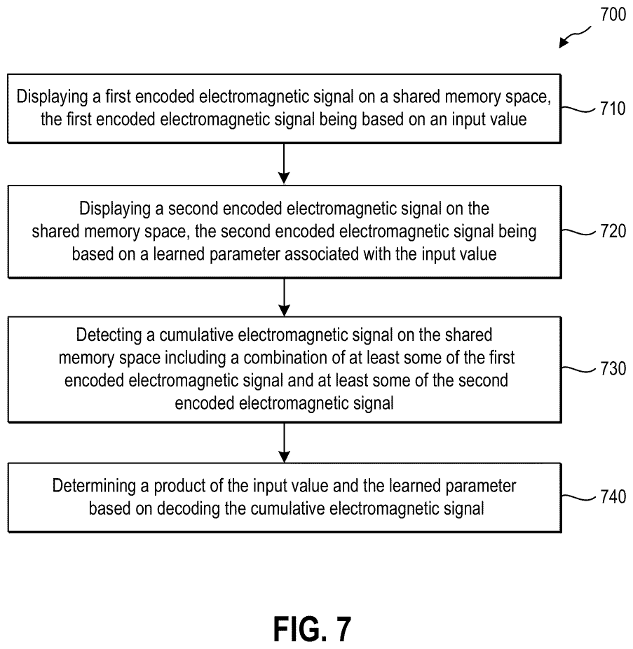

FIG. 7 illustrates a flow diagram for a method 700 or a series of acts for optical multiplication, according to at least one embodiment of the present disclosure. While FIG. 7 illustrates acts according to one embodiment, alternative embodiments may add to, omit, reorder, or modify any of the acts of FIG. 7.

In some embodiments, the method 700 includes an act 710 of displaying a first encoded electromagnetic signal on a shared memory space, the first encoded electromagnetic signal being based on an input value.

In some embodiments, the method 700 includes an act 720 of displaying a second encoded electromagnetic signal on the shared memory space, the second encoded electromagnetic signal being based on a learned parameter associated with the input value.

In some embodiments, the method 700 includes an act 730 of detecting a cumulative electromagnetic signal on the shared memory space including a combination of at least some of the first electromagnetic signal and at least some of the second electromagnetic signal.

In some embodiments, the method 700 includes an act 740 of determining a product of the input value and the learned parameter based on decoding the cumulative electromagnetic signal.

In some embodiments, the cumulative electromagnetic signal is a sum of the first encoded electromagnetic signal and the second encoded electromagnetic signal, and decoding the cumulative electromagnetic signal includes determining a sum value based on the input value and the learned parameter.

In some embodiments, the cumulative electromagnetic signal includes a combination of a light intensity of the first electromagnetic signal and a light intensity of the second electromagnetic signal. In some embodiments, displaying the second encoded electromagnetic signal includes displaying the second encoded electromagnetic signal at least partially collocated the first encoded electromagnetic signal. In some embodiments, displaying the first and second encoded electromagnetic signals on the shared memory space includes projecting the first encoded electromagnetic signal onto a shared screen with a first projector, and projecting the second encoded electromagnetic signals onto the shared screen with a second projector.

In some embodiments, the input value is an activation value for a node of a machine learning (ML) model and the learned parameter is a weight associated with the node of the ML model and determining the product includes determining a weighted activation value for the node.

In some embodiments, the method 700 further includes receiving the input value and generating the first encoded electromagnetic signal based on a transformation of the input value. In some embodiments, the second encoded electromagnetic signal is an encoded representation of a transformation of the learned parameter. In some embodiments, the transformation of the input value is a binary logarithm of the input value, and the transformation of the learned parameter is a binary logarithm of the learned parameter. In some embodiments, the method 700 includes decoding a sum value from the cumulative electromagnetic signal, wherein the sum value is a sum of the transformation of the input value and the transformation of the learned parameter. In some embodiments, determining the product of the input value and the learned parameter includes reverse transforming the sum value. In some embodiments, reverse transforming the sum value includes exponentiating the sum value, the sum value being a logarithmic value. In some embodiments, reverse transforming the sum value includes bit shifting the sum value, the sum value being a binary.

In some embodiments, the method 700 further includes transforming a set of inputs for a set of nodes of a first layer of a machine learning (ML) model into a set of logarithmic inputs for the set of nodes, and encoding the set of logarithmic inputs into a set of first encoded electromagnetic signals. In some embodiments, the method 700 further includes displaying the set of first encoded electromagnetic signals onto a shared memory space and displaying a set of second encoded electromagnetic signals onto the shared memory space superimposed with the set of first electromagnetic signals, wherein the set of second encoded electromagnetic signals are encoded representations of a set of logarithmic learned parameters from a set of learned parameters corresponding to the set of nodes. The method 700 may further include detecting a set of cumulative electromagnetic signals on the shared memory space based on the collocation of the sets of first and second electromagnetic signals, and decoding a set of sum values from the set of cumulative electromagnetic signals, each sum value being a sum of one of the logarithmic inputs of the set of logarithmic inputs and a corresponding logarithmic learned parameters of the set of logarithmic learned parameters. The method 700 may also include determining a set of weighted input values based on exponentiating the set of sum values, each of the weighted input values being a product of one of the inputs of the set of inputs and a corresponding learned parameter of the set of learned parameters.

In some embodiments, the method 700 further includes summing the set of weighted input values to generate a sum value for the set of nodes, and transmitting the sum value to one or more nodes of a second layer of the ML model.

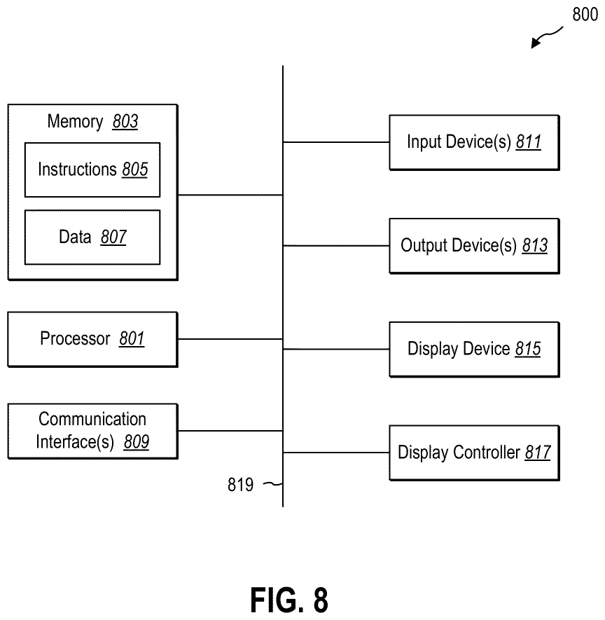

Turning now to FIG. 8, this figure illustrates certain components that may be included within a computer system 800, according to at least one embodiment of the present disclosure. One or more computer systems 800 may be used to implement the various devices, components, and systems described herein.

The computer system 800 includes a processor 801. The processor 801 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 805 and data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during execution of the instructions 805 by the processor 801.

A computer system 800 may also include one or more communication interfaces 809 for communicating with other electronic devices. The communication interface(s) 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 800 may also include one or more input devices 811 and one or more output devices 813. Some examples of input devices 811 include a keyboard, mouse, microphone, remote control device, button, joystick, trackball, touchpad, and lightpen. Some examples of output devices 813 include a speaker and a printer. One specific type of output device that is typically included in a computer system 800 is a display device 815. Display devices 815 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

### INDUSTRIAL APPLICABILITY

The following description from ¶¶[0105]-[0126] includes various embodiments that, where feasible, may be combined in any permutation. For example, the embodiment of ¶[105] may be combined with any or all embodiments of the following paragraphs. Embodiments that describe acts of a method may be combined with embodiments that describe, for example, systems and/or devices. Any permutation of the following paragraphs is considered to be hereby disclosed for the purposes of providing “unambiguously derivable support” for any claim amendment based on the following paragraphs. Furthermore, the following paragraphs provide support such that any combination of the following paragraphs would not create an “intermediate generalization.”

In some embodiments, a method for optical multiplication includes displaying a first encoded electromagnetic signal on a shared memory space, the first encoded electromagnetic signal being based on an input value, displaying a second encoded electromagnetic signal on the shared memory space, the second encoded electromagnetic signal being based on a learned parameter associated with the input value, detecting a cumulative electromagnetic signal on the shared memory space including a combination of at least some of the first electromagnetic signal and at least some of the second electromagnetic signal, and determining a product of the input value and the learned parameter based on decoding the cumulative electromagnetic signal.

In some embodiments, the cumulative electromagnetic signal is a sum of the first encoded electromagnetic signal and the second encoded electromagnetic signal, and decoding the cumulative electromagnetic signal includes determining a sum value based on the input value and the learned value.

In some embodiments, the cumulative electromagnetic signal includes a combination of a light intensity of the first electromagnetic signal and a light intensity of the second electromagnetic signal.

In some embodiments, displaying the second encoded electromagnetic signal includes displaying the second encoded electromagnetic signal at least partially collocated with the first encoded electromagnetic signal.

In some embodiments, the input value is an activation value for a node of a machine learning (ML) model and the learned parameters is a weight associated with the node of the ML model and determining the product includes determining a weighted activation value for the node.

In some embodiments, the method further includes receiving the input value and generating the first encoded electromagnetic signal based on a transformation of the input value.

In some embodiments, the second encoded electromagnetic signal is an encoded representation of a transformation of the learned parameter.

In some embodiments, the transformation of the input value is a binary logarithm of the input value, and the transformation of the learned parameter is a binary logarithm of the learned parameter.

In some embodiments, the method further includes decoding a sum value from the cumulative electromagnetic signal, wherein the sum value is a sum of the transformation of the input value and the transformation of the learned parameter.

In some embodiments, determining the product of the input value and learned parameter includes reverse transforming the sum value.

In some embodiments, reverse transforming the sum value includes exponentiating the sum value, the sum value being a logarithmic value.

In some embodiments, reverse transforming the sum value includes bit shifting the sum value, the sum value being a binary logarithmic value.

In some embodiments, displaying the first and second encoded electromagnetic signals on the shared memory space includes projecting the first encoded electromagnetic signal onto a shared screen with a first projector, and projecting the second encoded electromagnetic signals onto the shared screen with a second projector.

In some embodiments, displaying the first electromagnetic signal includes activating one or more first emitters positioned in the shared memory space and displaying the second electromagnetic signal includes activating one or more second emitters positioned in the shared memory space, at least a portion of the one or more first emitters being collocated with at least a portion of the one or more second emitters to generate the cumulative electromagnetic signal being as a combination of the first and second electromagnetic signals.

In some embodiments, a system includes one or more processors, a first display device, a second display device, an image sensor, one or more memory components in electronic communication with the one or more processors, and instructions stored in the one or more memory components, the instructions being executable by the one or more processors to display, with the first display device, a set of first encoded electromagnetic signals on a shared memory space, the set of first encoded electromagnetic signals being based on a set of input values, display, with the second display device, a set of second encoded electromagnetic signals on the shared memory space, the set of second encoded electromagnetic signals being based on a set of learned parameters associated with the set of input values, detect, with the image sensor, a set of cumulative electromagnetic signals on the shared memory space including a combination of the set of first electromagnetic signals and the set of second electromagnetic signals, and determine, with the one or more processors, a set of product values based on decoding the set of cumulative electromagnetic signals, the set of product values each being a product of one of the input values and one of the learned parameters.

In some embodiments, the one or more processors does not include a graphics processing unit (GPU).

In some embodiments, displaying the second encoded electromagnetic signal is not performed by a processing unit.

In some embodiments, the set of input values is an activation matrix for a set of nodes of a layer of a machine learning (ML) model, and the set of learned parameters is a weight matrix for the set of nodes of the layer of the ML model, and determining the set of product values includes determining a matrix product of the activation matrix and the weight matrix based on the detected set of cumulative electromagnetic signals being a sum of the set of first electromagnetic signals and the set of second electromagnetic signals.

In some embodiments, the set of input values are stored in a first memory component of the one or more memory components and the first processor generates and displays the set of first encoded electromagnetic signals with the first display device based on the set of input values store in the first memory component, and further comprising displaying the set of second encoded electromagnetic signals by the second display device with a second processor of the one or more processors, the set of learned parameters values being stored in a second memory component of the one or more memory components associated with the second processor.

In some embodiments, the instructions further include instructions for summing, with the one or more processors, the set of product values to generate a sum value, and transmitting the sum value to an additional processor.

In some embodiments, the one or more processors implement a set of nodes of a first layer of a ML model, and transmitting the sum value includes transmitting the sum value to a receiving node of a second layer of the M L model implemented by the additional processor.

In some embodiments, a method for optical matrix multiplication includes transforming a set of inputs for a set of nodes of a first layer of a machine learning (ML) model into a set of logarithmic inputs for the set of nodes, encoding the set of logarithmic inputs into a set of first encoded electromagnetic signals, displaying the set of first encoded electromagnetic signals onto a shared memory space, displaying a set of second encoded electromagnetic signals onto the shared memory space collocated with the set of first electromagnetic signals, wherein the set of second encoded electromagnetic signals are encoded representations of a set of logarithmic learned parameters transformed from a set of learned parameters corresponding to the set of nodes, detecting a set of cumulative electromagnetic signals on the shared memory space based on the collocation of the sets of first and second electromagnetic signals, decoding a set of sum values from the set of cumulative electromagnetic signals, each sum value being a sum of one of the logarithmic inputs of the set of logarithmic inputs and a corresponding logarithmic learned parameters of the set of logarithmic learned parameters, and determining a set of weighted input values based on exponentiating the set of sum values, each of the weighted input values being a product of one of the inputs of the set of inputs and a corresponding learned parameters of the set of learned parameters.

In some embodiments, the method further includes summing the set of weighted input values to generate a sum value for the set of nodes, and transmitting the sum value to one or more nodes of a second layer of the ML model.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or processing process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for optical multiplication, comprising:
displaying a first encoded electromagnetic signal on a shared memory space, the first encoded electromagnetic signal being based on an input value;
displaying a second encoded electromagnetic signal on the shared memory space, the second encoded electromagnetic signal being based on a learned parameter associated with the input value;
detecting a cumulative electromagnetic signal on the shared memory space including a combination of at least some of the first encoded electromagnetic signal and at least some of the second encoded electromagnetic signal; and
determining a product of the input value and the learned parameter based on decoding the cumulative electromagnetic signal.

2. The method of claim 1, wherein the cumulative electromagnetic signal is a sum of the first encoded electromagnetic signal and the second encoded electromagnetic signal, and decoding the cumulative electromagnetic signal includes determining a sum value based on the input value and the learned parameter.

3. The method of claim 1, wherein the cumulative electromagnetic signal includes a combination of a light intensity of the first encoded electromagnetic signal and a light intensity of the second encoded electromagnetic signal.

4. The method of claim 1, wherein displaying the second encoded electromagnetic signal includes displaying the second encoded electromagnetic signal at least partially collocated with the first encoded electromagnetic signal.

5. The method of claim 1, further comprising receiving the activation value and generating the first encoded electromagnetic signal based on a transformation of the input value, and wherein the second encoded electromagnetic signal is an encoded representation of a transformation of the learned parameter.

6. The method of claim 5, wherein the transformation of the input value is a binary logarithm of the input value, and the transformation of the learned parameter is a binary logarithm of the learned parameter.

7. The method of claim 5, further comprising decoding a sum value from the cumulative electromagnetic signal, wherein the sum value is a sum of the transformation of the input value and the transformation of the learned parameter.

8. The method of claim 7, wherein determining the product of the input value and the learned parameter includes reverse transforming the sum value.

9. The method of claim 8, wherein reverse transforming the sum value includes exponentiating the sum value, the sum value being a logarithmic value.

10. The method of claim 8, wherein reverse transforming the sum value includes bit shifting the sum value, the sum value being a binary logarithmic value.

11. The method of claim 1, wherein displaying the first and second encoded electromagnetic signals on the shared memory space includes projecting the first encoded electromagnetic signal onto a shared screen with a first projector, and projecting the second encoded electromagnetic signal onto the shared screen with a second projector.

12. The method of claim 1, wherein displaying the first encoded electromagnetic signal includes activating one or more first emitters positioned in the shared memory space and displaying the second encoded electromagnetic signal includes activating one or more second emitters positioned in the shared memory space, at least a portion of the one or more first emitters being collocated with at least a portion of the one or more second emitters to generate the cumulative electromagnetic signal as a combination of the first and second encoded electromagnetic signals.

13. A system, comprising:
one or more processors;
a first display device;
a second display device;
an image sensor;
one or more memory components in electronic communication with the one or more processors; and
instructions stored in the one or more memory components, the instructions being executable by the one or more processors to:
display, with the first display device, a set of first encoded electromagnetic signals on a shared memory space, the set of first encoded electromagnetic signals being based on a set of input values;
display, with the second display device, a set of second encoded electromagnetic signals on the shared memory space, the set of second encoded electromagnetic signals being based on a set of learned parameters associated with the set of input values;
detect, with the image sensor, a set of cumulative electromagnetic signals on the shared memory space including a combination of the set of first encoded electromagnetic signals and the set of second encoded electromagnetic signals; and
determine, with the one or more processors, a set of product values based on decoding the set of cumulative electromagnetic signals, the set of product values each being a product of one of the input values and one of the learned parameters.

14. The system of claim 13, wherein displaying the second encoded electromagnetic signal is not performed by a processing unit.

15. The system of claim 13, wherein the set of input values is an activation matrix for a set of nodes of a layer of a machine learning (ML) model, and the set of learned parameters is a weight matrix for the set of nodes of the layer of the ML model, and determining the set of product values includes determining a matrix product of the activation matrix and the weight matrix based on the detected set of cumulative electromagnetic signals being a sum of the set of first encoded electromagnetic signals and the set of second encoded electromagnetic signals.

16. The system of claim 13, wherein the set of input values are stored in a first memory component of the one or more memory components and a first processor of the one or more processors generates and displays the set of first encoded electromagnetic signals with the first display device based on the set of input values store in the first memory component, and further comprising displaying the set of second encoded electromagnetic signals by the second display device with a second processor of the one or more processors, the set of learned parameters being stored in a second memory component of the one or more memory components associated with the second processor.

17. The system of claim 13, further comprising summing, with the one or more processors, the set of product values to generate a sum value, and transmitting the sum value to an additional processor.

18. The system of claim 17, wherein the one or more processors implement a set of nodes of a first layer of a ML model, and transmitting the sum value includes transmitting the sum value to a receiving node of a second layer of the ML model implemented by the additional processor.

19. A method for optical matrix multiplication, comprising:
transforming a set of inputs for a set of nodes of a first layer of a machine learning (ML) model into a set of logarithmic inputs for the set of nodes;
encoding the set of logarithmic inputs into a set of first encoded electromagnetic signals;
displaying the set of first encoded electromagnetic signals on a shared memory space;
displaying a set of second encoded electromagnetic signals on the shared memory space collocated with the set of first encoded electromagnetic signals, wherein the set of second encoded electromagnetic signals are encoded representations of a set of logarithmic learned parameters transformed from a set of learned parameters corresponding to the set of nodes;
detecting a set of cumulative electromagnetic signals on the shared memory space based on the collocation of the sets of first and second encoded electromagnetic signals;
decoding a set of sum values from the set of cumulative electromagnetic signals, each sum value being a sum of one of the logarithmic inputs of the set of logarithmic inputs and a corresponding logarithmic learned parameters of the set of logarithmic learned parameters; and
determining a set of weighted input values based on exponentiating the set of sum values, each of the weighted input values being a product of an input of the set of inputs and a corresponding learned parameters of the set of learned parameters.

20. The method of claim 19, further comprising summing the set of weighted inputs values to generate a sum value for the set of nodes, and transmitting the sum value to one or more nodes of a second layer of the ML model.
